(19) United States
(12) Patent Application Publication
(10) Pub. No.: US 2026/0126238 A1
(43) Pub. Date: May 7, 2026

(54) REFRIGERATOR

(71) Applicant: LG ELECTRONICS INC., Seoul (KR)

(72) Inventors: Seongwon GWON, Seoul (KR); Jinho CHANG, Seoul (KR)

(21) Appl. No.: 19/372,508

(22) Filed: Oct. 29, 2025

(30) Foreign Application Priority Data
Nov. 4, 2024 (KR) 10-2024-0154521

(51) Int. Cl. F25D 23/02; E05F 15/619

(52) U.S. Cl. CPC F25D 23/028; E05F 15/619; E05Y 2201/426; E05Y 2201/638; E05Y 2900/31; F25D 2323/021

(57) ABSTRACT

Provided is a refrigerator. The refrigerator includes a refrigerator door including a first door opening and closing a storage chamber of a cabinet and a second door opening and closing an opening of the first door. A door opening device is installed inside the second door. The door opening device includes a pusher applying pushing force the first door by receiving a driving force of a driving unit, and a rotary wheel mounted on one side of the pusher to be contactable with the first door. The pusher can apply pushing force the first door in a state where the rotary wheel is in contact with the first door. The second door can be open by a reactive force against an applying pushing force of the pusher. Accordingly, the rotary wheel can suppress wear between the first door and the pusher of the door opening device.

### CROSS-REFERENCE TO RELATED APPLICATION

Pursuant to 35 U.S.C. § 119(a), this application claims the benefit of the earlier filing date and the right of priority to Korean Patent Application No. 10- 2024-0154521, filed on November 4, 2024, the contents of which are incorporated by reference herein in their entirety.

### BACKGROUND

### 1. Field

The disclosure relates to a refrigerator.

### 2. Description of the Related Art

Typically, a refrigerator may include a cabinet having a storage chamber and a door which opens and closes the storage chamber.

The storage chamber is surrounded by insulation walls, and thus the inside of the storage chamber is kept at a lower temperature than the temperature of the outside. Depending on a temperature range of the storage chamber, the storage chamber may be classified as a refrigerating chamber or a freezing chamber.

To put an object into or take it out of the storage chamber, a user opens the door.

Typically, the door is rotatably arranged on the cabinet, and a gasket is positioned between the door and the cabinet. Therefore, when the door is closed, the gasket seals between the door and the cabinet, suppressing cool air from leaking from the storage chamber. As the sealing force of the gasket increases, the effect of suppressing cool air leakage can increase.

To increase the sealing force of the gasket, the gasket may be implemented as a rubber magnet, and a magnet may be arranged inside the gasket.

However, as the sealing force of the gasket increases, a greater force is required to open the door.

Therefore, recently, refrigerators with an automatic door opening function have been provided.

A refrigerator is disclosed in Korean Patent Publication No. 10-2018-0119027, as a prior art document.

The refrigerator of the prior art document includes a cabinet having at least one storage chamber inside, a door arranged on one side of the cabinet to open and close the storage chamber, and a door opening device moving the door to open the storage chamber by a driving force of a motor.

For example, the door may include an inner door which is arranged in close contact with a front surface of the cabinet, and an outer door which is arranged on a front surface of the inner door.

The door opening device is positioned on the cabinet, and opens the inner door by pushing the inner door.

However, in the case of the prior art document, when the inner door is open, the outer door is open together with the inner door, so there is a disadvantage in that the outer door cannot be open automatically.

Furthermore, in the case of the prior art document, the door opening device is arranged on the cabinet. When the outer door is to be open using the door opening device, there is a disadvantage in that the length of the door opening device increases and the structure becomes complicated to push the outer door without interfering with the inner door.

### SUMMARY

An aspect of the disclosure is to provide a refrigerator with a structure which is capable of solving those problems and other drawbacks.

A first aspect is to provide a refrigerator having a structure which is capable of automatically opening a second door, which is located outside in a door-in-door structure including a first door and the second door.

A second aspect is to provide a refrigerator having a structure which is capable of opening a second door automatically or manually.

A third aspect is to provide a refrigerator having a structure which is capable of maintaining a coupled state between a first door and a second door when the first door is open.

A fourth aspect is to provide a refrigerator having a structure which is capable of automatically opening a second door (outer door) without interfering with a first door (inner door).

A fifth aspect is to provide a refrigerator with a structure which is capable of automatically opening a second door in a contact manner.

A sixth aspect is to provide a refrigerator having a structure which is capable of suppressing scratches and wear of a second door caused by friction with a contact surface of a first door when the second door is automatically open.

A seventh aspect is to provide a refrigerator having a structure which is capable of simplifying a structure of a door opening device.

An eighth aspect is to provide a refrigerator having a structure which is capable of securing an installation space for other components by efficiently utilizing an inner space of a second door.

As a result of an intensive research, the inventors of the disclosure can achieve the first to eighth aspects by the following embodiment of the disclosure.

To achieve those aspects, a refrigerator according to an embodiment includes a cabinet, a first door, a second door, and a door opening device. The cabinet has a storage chamber.

The first door is rotatably mounted on the cabinet to open and close the storage chamber, and has an opening. The second door is rotatably mounted on the first door to open and close the opening.

The door opening device is installed inside the second door and configured to automatically open the second door.

The door opening device may include a case, a driving unit installed inside the case, a pusher connected to the driving unit and applying pushing force the first door by receiving a driving force from the driving unit, and a rotary wheel mounted on one side of the pusher to be contactable with the first door.

The pusher may apply pushing force the first door through the rotary wheel while in contact with the first door, and the second door may be open by a reactive force of the first door against an applying pushing force of the pusher.

Through this, the rotary wheel can suppress scratches and wear problems from occurring due to contact with the first door when the second door is open.

According to an embodiment, the rotary wheel may be formed in one or a combined shape of at least two of a cylindrical shape, a spherical shape, and a circular shape. Accordingly, the rotary wheel can minimize wear of the first door.

According to an embodiment, a center of the rotary wheel may be rotatably supported on one side of the pusher by a central shaft, and an outer circumferential surface of the rotary wheel may be in rolling-contact with the first door according to the rotation of the pusher.

According to an embodiment, the pusher may include a first link installed inside the case to enable simultaneous linear movement and rotation, and a second link hinge-coupled to one end of the first link to be rotatable in conjunction with the first link.

The rotary wheel may be mounted on one end of the second link to be rotatable by a central shaft. The first link and the second link can rotate in opposite directions depending on the operation of the driving unit when the second door is open.

According to an embodiment, the door opening device may include a second rack linearly movable in both directions.

The pusher may include a first link hinge-coupled to the second rack to linearly move and rotate simultaneously according to the movement of the second rack, and a second link hinge-coupled to one end of the first link to rotate in an opposite direction to a rotational direction of the first link.

According to an embodiment, the door opening device may further include a first rack installed inside the case to be linearly movable in the both directions by receiving the driving force of the driving unit, and to transmit the driving force to the second rack.

According to an embodiment, the pusher may include a first link mounted to be rotatable around a first coupling pin, and a second link hinge-coupled to the first link via a second coupling pin and mounted to be rotatable around a third coupling pin in an opposite direction to the rotational direction of the first link.

The rotary wheel may be rotatably mounted on one end of the second link in an opposite direction to the third coupling pin based on the second coupling pin.

According to an embodiment, the door opening device may include a second rack linearly movable in both directions.

One end of the first link may be hinge-coupled to the second rack by the first coupling pin, to rotate while linearly moving together with the second rack.

According to an embodiment, the second link may further include a link accommodating portion accommodating a portion of the first link.

Another end of the first link may be accommodated in the link accommodating portion and may be hinge-coupled to the second link by the second coupling pin.

According to an embodiment, the second door and the first door may be arranged in a front-rear direction of the cabinet.

The door opening device may further include a first rack extending in a left-right direction, and mounted in the case to reciprocate in the left-right direction by receiving the driving force of the driving unit, and a second rack connected to the first rack and mounted to be movable in the left-right direction together with the first rack.

According to an embodiment, the driving unit may include a motor.

The door opening device may further include a driving force transmission unit configured to transmit the driving force of the driving unit to the first rack.

The driving force transmission unit may include a driving gear connected to the driving unit, and a driven gear engaged with the driving gear at a preset gear ratio.

Through this, the driving force transmission unit can increase a torque by reducing a rotational speed of the motor.

According to an embodiment, the first rack may include a rack gear extending in the left-right direction and engaged with the driven gear to convert a rotational force of the driven gear into a linear force in the left-right direction.

Through this, the rack gear can convert a rotational motion of the driven gear into a linear motion of the first rack.

According to an embodiment, the first rack may include a first contact protrusion, and a second contact protrusion arranged to be spaced apart from the first contact protrusion in the left-right direction.

The second rack may include a body extending in the left-right direction, and an operating protrusion protruding toward the first rack from one side of the body, and arranged between the first contact protrusion and the second contact protrusion, to be selectively in contact with one of the first contact protrusion and the second contact protrusion according to a change in position of the first rack and thus receive the driving force of the first rack.

When the operating protrusion and the first contact protrusion are brought into contact, the second rack may move in one direction. When the operating protrusion and the second contact protrusion are brought into contact, the second rack may move in an opposite direction to the one direction.

Through this, the driving force of the first rack can be transmitted to the second rack. A locking device may be unlocked before the second door is open.

According to an embodiment, the refrigerator may further include a connection protrusion extending in the left-right direction between the first contact protrusion and the second contact protrusion, to connect the first contact protrusion and the second contact protrusion.

Through this, the connection protrusion can increase the rigidity and support force of the first contact protrusion and the second contact protrusion.

The operating protrusion may include a first part extending in the front-rear direction and arranged between the first contact protrusion and the second contact protrusion, to be selectively in contact with one of the first contact protrusion and the second contact protrusion, and a second part extending in the left-right direction from one end of the first part.

Through this, the second part can increase the rigidity and support force of the operating protrusion.

According to an embodiment, the refrigerator may further include a locking device arranged inside the second door to lock or unlock the first door and the second door.

The locking device may include a latch bar extending in an up-down direction and mounted to be rotatable around a hinge pin in the front-rear direction, a latch protruding from a lower end of the latch bar toward the first door, and a latch hook protruding upward from the latch to be caught on an engaging portion arranged on the first door.

According to an embodiment, the locking device may further include an operating unit protruding from the lower end of the latch bar toward outside of the second door, so as to be operated by a user. Through this, the operating unit can unlock the locking device by a manual operation.

According to an embodiment, the door opening device may include a first rack extending in the left-right direction inside the case and mounted to be linearly movable in the left-right direction by receiving the driving force from the driving unit, and a cam arranged on one end of the first rack to transmit a driving force of the first rack to the locking device to unlock the locking device when the second door is open.

The cam may include a first contact surface formed inside the case to be inclined in a direction away from the locking device with respect to the front-rear direction, and a second contact surface extending in the left-right direction from the first contact surface.

The locking device may include a rotary bar having one end coupled to an upper end of the latch bar, and another end extending toward the first contact surface in the left-right direction to be in contact with the first contact surface.

When the cam moves toward the rotary bar, the rotary bar may rotate toward the first door along the first contact surface, so that the locking device can be automatically unlocked.

According to an embodiment, the other end of the rotary bar may have a spherical or hemispherical shape. Through this, the cam and the rotary bar can slide by contact with each other and operate separately. The second door may be open in an automatic or manual mode.

According to another embodiment, the pusher may include a first link rotatably installed inside the case, and a second link hinge-coupled to one end of the first link to be rotatable in conjunction with the first link.

The first link and the second link may be coupled by a key to be rotatable in opposite directions. Through this, the first link and the second link can be folded or unfolded relative to each other, like a joint, around the key to apply pushing force the second door or return the second door to an initial position. The key can simplify a joint coupling structure between the first link and the second link.

According to another embodiment, the key may include a shaft portion serving as a rotational shaft of the first link or the second link, and a support portion protruding radially outward from one end of the shaft portion to rotatably support the first link or the second link.

A key accommodating portion may be formed on the first link or the second link. The key accommodating portion may include a shaft hole formed through the first link or the second link in the up-down direction to accommodate the shaft portion, and a support hole recessed radially outward in the shaft hole such that the support portion passes therethrough.

Through this, the key can simplify not only the structure of the door opening device but also a coupling structure of the first link and the second link.

According to another embodiment, the support portion may be arranged as a plurality of support portions, which are arranged to face each other in a radial direction of the shaft portion.

According to another embodiment, the key accommodating portion may further include a support portion accommodating portion formed on one side of the shaft hole and the support hole based on an axial direction of the shaft portion, so that the support portion is rotatable while being accommodated therein.

According to another embodiment, the pusher may include a first link mounted to be rotatable around a first key, and a second link hinge-coupled to the first link via a second key and mounted to be rotatable around a third key in an opposite direction to the rotational direction of the first link.

The rotary wheel may be rotatably mounted on one end of the second link in an opposite direction to the third key based on the second key.

Through this, the rotary wheel can minimize scratches and wear resulting from the contact with the first door.

According to another embodiment, the door opening device may include a first rack mounted to be linearly movable in both directions by receiving the driving force from the driving unit, and a second rack connected to the first rack to be linearly movable in the both directions together with the first rack.

One end of the first link may be hinge-coupled to the second rack by the first key, so as to be rotatable while linearly moving together with the second rack.

Through this, the door opening device can be configured compactly.

According to another embodiment, the first key may include a first shaft portion extending from one side of the second rack and serving as a rotational shaft of the first link, and a first support portion protruding radially outward from one end of the first shaft portion to rotatably support the first link.

A first key accommodating portion may be arranged on one end of the first link. The first key accommodating portion may include a first shaft hole formed therethrough in the up-down direction to accommodate the first shaft portion, and a first support hole recessed radially outward in the first shaft hole such that the first support portion passes therethrough.

Through this, the coupling structure of the first key and the first key accommodating portion can not only simplify the coupling structure of the first link, but also improve the assembling ability.

According to another embodiment, the second key may include a second shaft portion protruding from one side of the second link to be coupled through the first link so as to be rotatable relative to the first link, and a second support portion protruding radially outward from one end of the second shaft portion to rotatably support the first link.

A second key accommodating portion may be arranged on another end of the first link. The second key accommodating portion may include a second shaft hole formed therethrough in the up-down direction to accommodate the second shaft portion, and a second support hole recessed radially outward into the second shaft hole such that the second support portion passes therethrough.

Through this, the coupling structure of the second key and the second key accommodating portion can not only simplify the coupling structure of the first link and the second link, but also improve the assembling ability.

According to another embodiment, the door opening device may further include a link support portion installed inside the case. The third key may include a third shaft portion protruding from the link support portion and serving as a rotational shaft of the second link, and a third support portion protruding radially outward from one end of the third shaft portion to rotatably support the second link.

A third key accommodating portion may be arranged on another end of the second link. The third key accommodating portion may include a third shaft hole formed therethrough in the up-down direction to accommodate the third shaft portion, and a third support hole recessed radially outward into the third shaft hole such that the third support portion passes therethrough.

Through this, the coupling structure of the third key and the third key accommodating portion can not only simplify the coupling structure of the second link, but also improve the assembling ability.

According to an embodiment, the following effects can be obtained.

First, a refrigerator according to an embodiment includes a door opening device arranged on a second door, which is arranged on an outside, in a door-to-door structure including a first door and the second door. Through this, the door opening device can automatically open the second door.

Second, the second door includes a locking device. The locking device includes a latch bar and a latch that are installed to be rotatable in a front-rear direction. The latch may be coupled to an engaging portion of the first door when the second door is closed. This can allow the first and second doors to remain coupled to each other.

Third, the locking device may be connected to the door opening device. The locking device may be rotated and unlocked by the operation of the door opening device before the second door is open. The door opening device may return to its initial position after the opening of the second door is completed.

When the door opening device is returned to its initial position, the locking device may be rotated to a lock position. The locking device includes an operating unit. The operating unit includes a latch bar exposed toward the front of the second door in an opposite direction to a latch based on the latch bar. When the user applies pushing force the operating unit, the locking device may be rotated to an unlock position.

The locking device may operate to the unlock position by a manual operation, separate from the operation of the door opening device.

Therefore, the user can open the second door automatically or manually using the door opening device.

Fourth, the second door includes a pusher. The pusher is arranged to be contactable with the first door. The pusher faces the first door and is mounted on the second door to be rotatable in a front-rear direction. The pusher may rotate by receiving a driving force from the driving unit of the door opening device.

Through this, the second door can apply pushing force the first door through the pusher and can be open by a reactive force of the first door against an applying pushing force of the pusher.

Fifth, the pusher may apply pushing force the first door while in contact with the front surface of the first door. Through this, the second door can be open automatically by providing the applying pushing force to the first door through the contact of the pusher.

Sixth, a rotary wheel may be rotatably installed on one side of the pusher. The rotary wheel may be formed in a circular shape. The rotary wheel may apply pushing force the first door and rotate at the same time while in contact with the first door when the second door is open.

Through this, the rotary wheel can suppress scratches or wear from occurring on a contact surface of the first door due to friction caused by the contact between the pusher and the first door.

Seventh, the door opening device includes a driving unit, a first rack, and a second rack. The first rack may linearly reciprocate between a first position and a second position by receiving the driving force from the driving unit. The second rack may be connected to the first rack to receive the driving force from the first rack. The pusher includes a first link rotatably coupled to the second rack, and a second link rotatably coupled to the first link.

For example, the pusher may be implemented in a two-section link structure. A plurality of links may be rotatably coupled together using a key. The key may include a shaft portion and a support portion. The shaft portion may serve as a rotational shaft of the link. The support portion may be arranged on one side of the shaft portion to rotatably support the link.

One end of the first link is hinge-coupled to the second rack by a first key. Another end of the first link is hinge-coupled to one end of the second link by a second key. Another end of the second link is hinge-coupled to the inside of the second door by a third key.

As the first rack moves from a first position to a second position, the second rack may also move in the same direction together with the first rack. As the second rack moves and a distance between the first and third keys is reduced, the first link rotates clockwise around the first key and the second link rotates counterclockwise around the third key. The other end of the first link and the one end of the second link, which are coupled to each other through the second key, may protrude toward the first door to apply the applying pushing force to the first door.

Through this, the key may include a support portion rotatably supporting the link, so that there is no need to form a separate support structure on the second rack, thereby simplifying the structure of the second rack.

The key may include a shaft portion serving as a rotational shaft of the link, and thus can replace a pin-coupling structure which is long in an up-down direction, thereby shortening the length of the shaft portion and compactly configuring the rotation-coupling structure of the pusher.

Eighth, as the structure of the second rack is simplified and the rotation-coupling structure of the link is configured compactly, the installation space of the door opening device inside the second door can be reduced. Therefore, a space can be secured in the inner space of the second door to additionally install other components, for example, a lighting device, such as an LED module. This can also allow for an efficient use of the inner space of the second door.

### BRIEF DESCRIPTION OF THE DRAWINGS

The above and other aspects, features and other advantages of the disclosure will be more clearly understood from the following detailed description taken in conjunction with the accompanying drawings, in which:

FIG. 1 is a front perspective view of a refrigerator according to an embodiment;

FIG. 2 is a front view of an open state of a second door of a refrigerating chamber door in FIG. 1;

FIG. 3 is a front view of an open state of the refrigerating chamber door and a freezing chamber door in FIG. 1;

FIG. 4 is an enlarged view of a portion "IV" in FIG. 1, which is a conceptual view of a first door and the second door in a state where a locking device is located at a lock position;

FIG. 5 is a conceptual view of an engaging portion of the first door with which the locking device of FIG. 4 engages;

FIG. 6 is a conceptual view of a state in which a pusher is mounted to a rear surface of the second door in FIG. 2;

FIG. 7 is a conceptual view of a state in which the pusher protrudes from a rear surface of the second door in FIG. 6;

FIG. 8 is a conceptual view of a state in which the door opening device is installed inside the second door in FIG. 6;

FIG. 9 is a conceptual view of the door opening device in FIG. 8, viewed from the bottom;

FIG. 10 is a perspective view of a locked state of the locking device before operation of the door opening device when the second door is closed, viewed from the rear of the second door;

FIG. 11 is a perspective view of a locked state of the locking device before operation of the door opening device when the second door is closed, viewed from the front of the second door;

FIG. 12 is a conceptual view of a locked state of the locking device before operation of the door opening device when the second door is closed, viewed from the rear of the second door;

FIG. 13 is a conceptual view of a locked state of the locking device before operation of the door opening device when the second door is closed, viewed from the front of the second door;

FIG. 14 is a conceptual view of a first rack of FIG. 10, viewed from the bottom;

FIG. 15 is an exploded perspective view of a rotary bar and the locking device in FIG. 10;

FIG. 16 is a conceptual view of a second rack in FIG. 10;

FIG. 17 (a) and (b) is a conceptual view for explaining the operation of the second rack according to the movement of the first rack in FIG. 10;

FIG. 18 is a perspective view for explaining the coupling relationship between the second rack and the pusher in FIG. 10;

FIG. 19 is an exploded view of the second rack and the pusher in FIG. 18;

FIG. 20 (a) and (b) is a conceptual view of an operating state of the pusher according to the movement of the second rack in FIG. 18;

FIG. 21 is a block diagram of a configuration for controlling the opening of the second door of the refrigerator according to an embodiment;

FIG. 22 is a flowchart of sequential operations of the door opening device and the locking device according to a movement distance of the first rack according to an embodiment;

FIG. 23 is a conceptual view of a state in which the locking device has been rotated to an unlocked state in response to the first rack being moved by a first distance in FIG. 10;

FIG. 24 is a conceptual view of a state in which the pusher has been rotated to protrude from the second door after the locking device is unlocked, in response to the first rack being moved by a third distance in FIG. 10;

FIG. 25 is a conceptual view of a state in which the second door is open by the pusher pushing the front surface of the first door in FIG. 24;

FIG. 26 is a conceptual view of a state in which a door opening device according to another embodiment is installed inside a second door;

FIG. 27 is a conceptual view of a state in which the door opening device is installed inside a case in FIG. 26;

FIG. 28 is a conceptual view of a coupled state between a second rack and a pusher in FIG. 27, viewed from the rear of the second door;

FIG. 29 is a conceptual view of a coupled state between the second rack and the pusher in FIG. 28, viewed from the top;

FIG. 30 (a) and (b) is a set of a bottom perspective view and a bottom view of a coupled state between the second rack and the pusher in FIG. 29;

FIG. 31 is an exploded perspective view of the second rack and the pusher in FIG. 29;

FIG. 32 (a) and (b) is a set of an exploded view and a cross-sectional view of a state before a first key of the second rack is coupled to a first key accommodating portion of a first link;

FIG. 33 (a) and (b) is a conceptual view of a state in which the first key is temporarily coupled by insertion into a first key hole of the first key accommodating portion in FIG. 32;

FIG. 34 (a) and (b) is a conceptual view of a state in which the first link is rotated 90 degrees around the first key and coupled to the first key;

FIG. 35 (a) and (b) is a set of an exploded view and a cross-sectional view of a state before a second key of a second link is coupled to a second key accommodating portion of the first link in FIG. 34;

FIG. 36 (a) and (b) is a conceptual view of a state in which the first key is temporarily coupled by insertion into a second key hole of the second key accommodating portion in FIG. 35;

FIG. 37 (a) and (b) is a conceptual view of a state in which the first link and the second link are coupled to each other by 90-degree rotation of the second link around the second key in FIG. 36;

FIG. 38 (a) and (b) is a set of an exploded view and a cross-sectional view of a state before a third key of a link support portion is coupled to a third key accommodating portion of the second link in FIG. 37;

FIG. 39 (a) and (b) is a conceptual view of a state in which the third key is temporarily coupled by insertion into a third key hole of the third key accommodating portion in FIG. 38; and

FIG. 40 (a) and (b) is a conceptual view of a state in which the second link and the link support portion are coupled to each other by 90-degree rotation of the link support portion around the third key.

### DETAILED DESCRIPTION OF THE EMBODIMENTS

Hereinafter, a refrigerator according to an embodiment will be described in detail with reference to the accompanying drawings. When applying reference numerals to components of each drawing, it should be noted that the same or equivalent components are given the same or equivalent reference numerals even if they are shown on different drawings. In describing an embodiment of the disclosure, when a detailed description of a related known configuration or function is determined to obscure understanding of the embodiment of the disclosure, the detailed description is omitted.

### 1. Definition of Terms

In describing components of embodiments, terms such as first, second, A, B, (a), and (b) may be used. These terms are only intended to distinguish one element from another, and do not limit the nature, order, or sequence of the elements. It will be understood that although the terms first, second, and the like may be used herein to describe various elements, these elements should not be limited by these terms. These terms are generally only used to distinguish one element from another.

It will be understood that when an element is referred to as being "connected with" another element, the element may be connected with the another element or intervening elements may also be present. In contrast, when an element is referred to as being "directly connected with" another element, there are no intervening elements present.

The singular forms are intended to include the plural forms as well, unless the context clearly indicates otherwise.

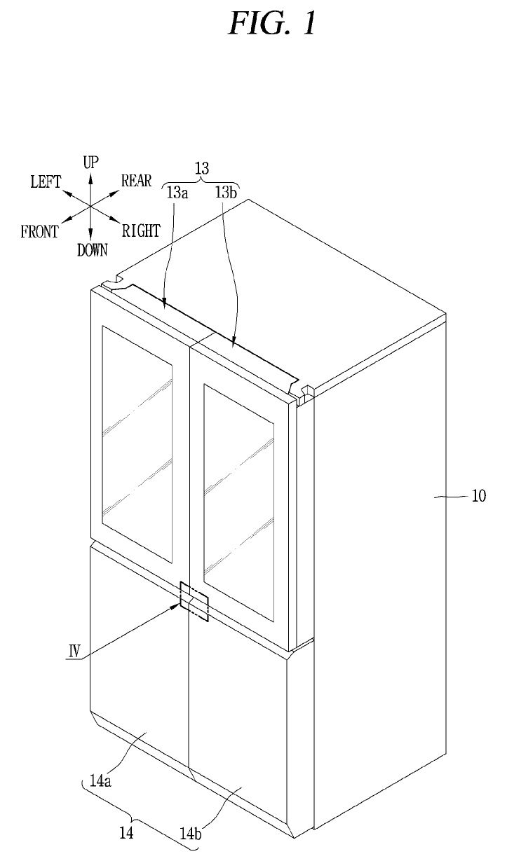

The terms "front side," "rear side," "left," "right," "upper" and "lower" used herein will be understood with reference to a coordinate system shown in FIG. 1.

The term "front-rear direction" used in the following description may be referred to as an X-axis direction in an XYZ orthogonal coordinate system. The term "left-right direction" may refer to a Y-axis direction in the XYZ orthogonal coordinate system. The term "up-down direction" may refer to a Z-axis direction in the XYZ orthogonal coordinate system.

A first door used in the following description may be referred to as an inner door or a main door. A second door may be referred to as an outer door or a sub-door.

The front surface of the second door is a surface which forms the front appearance of a refrigerator door. The rear surface of the second door is a surface facing the first door.

The front surface of the first door is a surface which forms the front appearance of the first door and faces the rear surface of the second door. The rear surface of the first door is a surface facing a cabinet or storage chamber.

### 2. Description of configuration of refrigerator according to embodiment

Hereinafter, each component of a refrigerator according to an embodiment will be described with reference to the accompanying drawings.

FIG. 1 is a front perspective view of a refrigerator according to an embodiment.

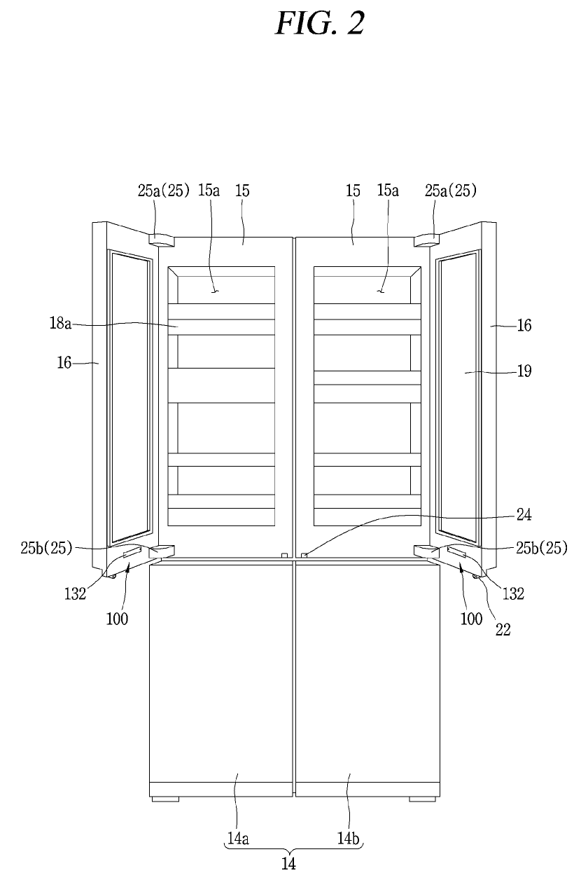

FIG. 2 is a front view of an open state of a second door 16 of a refrigerating chamber door 13 in FIG. 1.

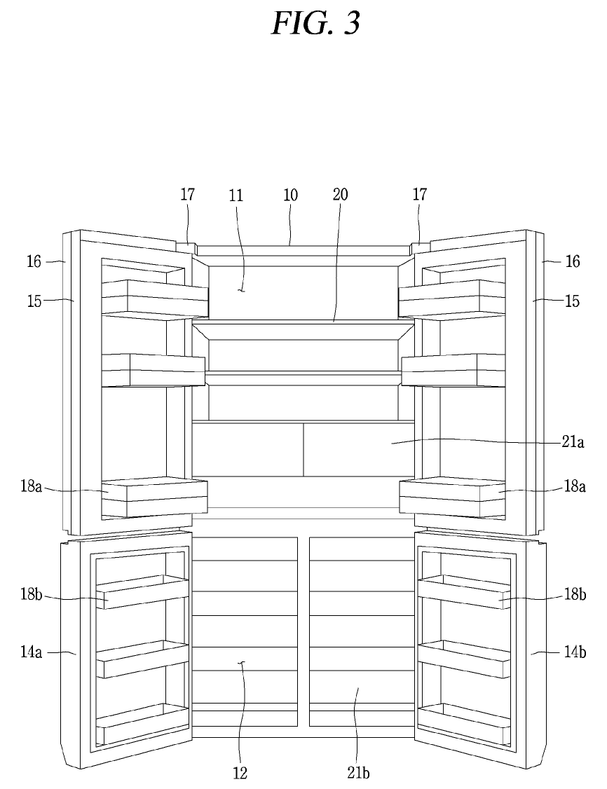

FIG. 3 is a front view of an open state of a refrigerating chamber door 13 and a freezing chamber door 14 in FIG. 1.

Referring to FIGS. 1 to 3, a refrigerator according to an embodiment includes a cabinet 10 and a refrigerator door 13 and 14. The cabinet 10 includes an outer case and an inner case. The outer case forms the appearance of the refrigerator. The inner case forms a storage chamber 11 and 12 therein. An insulating material is arranged between the outer case and the inner case. The insulating material blocks heat transfer due to a temperature difference between the outside of the cabinet 10 and the storage chamber 11 and 12.

The refrigerator door 13 and 14 may open and close the storage chamber 11 and 12.

The storage chamber 11 and 12 may include, for example, a refrigerating chamber 11 and a freezing chamber 12. Although not limited, in this embodiment, the refrigerating chamber 11 may be located above the freezing chamber 12.

Depending on the shape of the refrigerator, the freezing chamber 12 and refrigerating chamber 11 may be arranged on the left and right, or the freezing chamber 12 may be positioned above the refrigerating chamber 11.

The refrigerator door may include a refrigerating chamber door 13 and a freezing chamber door 14. The refrigerating chamber door 13 may be rotatably mounted on a front surface of the cabinet 10 to open and close the refrigerating chamber 11. The freezing chamber door 14 may be rotatably mounted on the front surface of the cabinet 10 to open and close the freezing chamber 12.

The refrigerating chamber door 13 may include a pair of doors. One of the pair of doors, for example, a first refrigerating chamber door 13a, may be arranged on the left side of the cabinet 10. The other of the pair of doors, for example, a second refrigerating chamber door 13b may be arranged on the right side of the cabinet 10.

The first refrigerating chamber door 13a opens and closes a portion of the refrigerating chamber 11. The second refrigerating chamber door 13b may open and close the other portion of the refrigerating chamber 11.

The freezing chamber door 14 may include a pair of doors. One of the pair of doors, for example, a first freezing chamber door 14a, may be arranged on the left side of the cabinet 10. The other of the pair of doors, for example, a second freezing chamber door 14b may be arranged on the right side of the cabinet 10.

The first freezing chamber door 14a opens and closes a portion of the freezing chamber 12. The second freezing chamber door 14b may open and close the other portion of the freezing chamber 12.

In another example, the freezing chamber 12 may be partitioned left and right or up and down, and the first freezing chamber door 14a may open and close one partitioned space, and the second freezing chamber door 14b may open and close the other partitioned space.

This specification states that there is no limitation on the number or arrangement of the refrigerating chamber door 13 and freezing chamber door 14. For example, the storage chamber 11 and 12 may include only the refrigerating chamber 11.

At least one of the first and second refrigerating chamber doors 13a and 13b may include a first door 15 which opens and closes at least a portion of the refrigerating chamber 11, and a second door 16 which is rotatable relative to the first door 15 to open and close an opening 15a of the first door 15.

This embodiment shows an example in which each of the first and second refrigerating chamber doors 13a and 13b includes the first door 15 and the second door 16.

The first door 15 may be rotatably mounted on the cabinet 10 by a first hinge 17. The first hinge 17 may be arranged in plurality. The plurality of first hinges 17 may rotatably support the first and second refrigerating chamber doors 13a and 13b.

The first hinge 17 may include a first upper hinge, a plurality of first middle hinges, and a first lower hinge.

The first upper hinge may connect an upper side of the first door 15 and an upper side of the cabinet 10. One of the plurality of first middle hinges may connect a lower side of the first door 15 and a middle portion of the cabinet 10. The corresponding first middle hinge and the first lower hinge may rotatably support the first and second freezing chamber doors 14a and 14b.

Another one of the plurality of first middle hinges may connect an upper side of the freezing chamber door 14 and a middle portion of the cabinet 10. The first lower hinge may connect a lower side of the freezing chamber door 14 and a lower side of the cabinet 10.

The second door 16 may be rotatable relative to the first door 15. The second hinge 25 may connect the first door 15 and the second door 16 such that the second door 16 can rotate relative to the first door 15.

The second hinge 25 may be arranged in plurality. The plurality of second hinges 25 may rotatably support the second doors 16 of the first and second refrigerating chamber doors 13a and 13b.

The second hinge 25 may include a second upper hinge 25a and a second middle hinge 25b. The second upper hinge 25a may connect upper sides of the first door 15 and the second door 16. The second middle hinge 25b may connect lower sides of the first door 15 and the second door 16.

The first door 15 may include an opening 15a. The second door 16 may open and close the opening 15a.

The second door 16 may cover the opening 15a on the front surface of the first door 15. In another example, the second door 16 may cover the opening 15a while at least a portion of the second door 16 is accommodated in the opening 15a.

The first door 15 may include at least one basket 18a. The basket 18a may be mounted on a rear surface of the first door 15 or a surface forming the opening 15a.

At least one of the first and second freezing chamber doors 14a and 14b may include a basket 18b. This embodiment shows an example in which the basket 18b is arranged on each of the first and second freezing chamber doors 14a and 14b.

The second door 16 may include a panel assembly 19. The panel assembly 19 may include at least one panel which is formed of a glass material or a material that allows light transmission.

When a lighting unit arranged in the refrigerator is turned on, the storage chamber 11 and 12 or the inside of the first door 15 can be visually seen through the panel assembly 19 while the second door 16 is closed.

In some embodiments, at least one shelf 20 may be arranged in the refrigerating chamber 11. At least one drawer 21a may be arranged in the refrigerating chamber 11 to be drawn in and out in a sliding manner.

At least one drawer 21b may be arranged in the freezing chamber 12 to be drawn in and out in a sliding manner. Of course, the shelf 20 or the drawers 21a and 21b are optional and may be omitted.

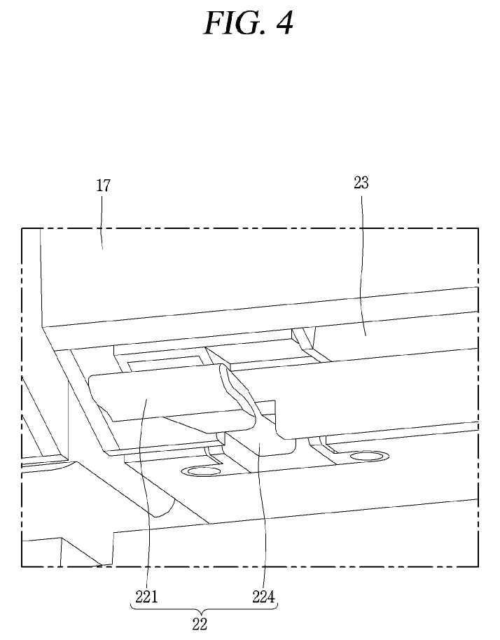

FIG. 4 is an enlarged view of a portion "IV" in FIG. 1, which is a conceptual view of the first door 15 and the second door 16 in a state where a locking device 22 is located at a lock position.

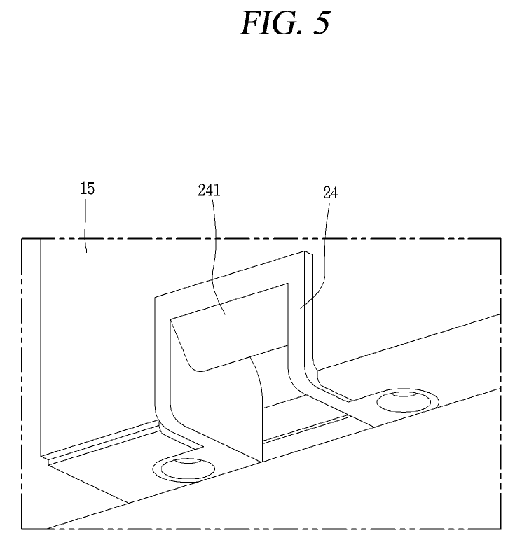

FIG. 5 is a conceptual view of an engaging portion 24 of the first door 15 with which the locking device 22 of FIG. 4 engages.

Referring to FIGS. 1 to 5, the first door 15 may be open manually or automatically.

In the case of automatically opening the first door 15, although not shown, a main opening device for opening the first door 15 may be arranged in the first door 15 or the cabinet 10.

The location or structure of the main opening device for opening the first door 15 may employ various technologies previously disclosed by the applicant of the disclosure. That is, as the first door 15 is open by the main opening device, the first door 15 and the second door 16 can rotate together. Of course, the main opening device may be omitted

The second door 16 may be open while the first door 15 is closed. The first door 15 may be open while the second door 16 is closed.

At this time, when the first door 15 is open, it is necessary to suppress the second door 16 from rotating relative to the first door 15.

Therefore, in this embodiment, the refrigerating chamber door 13 may further include a locking device 22 which allows the first door 15 and the second door 16 to remain locked or unlocked.

The locking device 22 may move from a lock position to an unlock position. The locking device 22 may return from the unlock position to the lock position.

The locking device 22 may be moved by the user’s manual operation. The locking device 22 may be automatically moved by a door opening and closing device to be described later.

For example, when manual opening of the second door 16 is required, the user may operate the locking device 22 to move from the lock position to the unlock position.

When the locking device 22 moves to the unlock position, the second door 16 and the first door 15 may be in the unlocked state.

For example, when the user applies pushing force upward an operating unit 221 of the locking device 22, which protrudes downward below a lower surface of the second door 16, the locking device 22 may be unlocked.

The locking device 22 may be rotatably arranged on the second door 16. The second door 16 may include a handle 23. The handle 23 may be recessed into one side of the second door 16.

For example, the handle 23 may be arranged on the lower side of the second door 16.

The locking device 22 may be arranged on the lower side of the second door 16. The locking device 22 may be located outside the handle 23. In another example, the locking device 22 may be positioned inside a recessed space formed by the handle 23.

The first door 15 and the second door 16 may be locked in the lock position of the locking device 22. In this state, when the user pulls the handle 23, the first door 15 and the second door 16 can rotate together.

When the user pulls the handle 23 while the second door 16 and the first door 15 are unlocked, the second door 16 can be rotated while the first door 15 is closed.

The first door 15 may include an engaging portion 24 with which the locking device 22 engages. The engaging portion 24 may be formed integrally with or coupled to a member which defines the appearance of the first door 15.

The engaging portion 24, for example, may be located on the lower side of the first door 15.

The engaging portion 24 may form a space for accommodating a portion of the locking device 22. The engaging portion 24 may include an engaging wall 241 with which the portion of the locking device 22 located inside the space engages.

An upper surface of the engaging wall 41 may include an inclined surface. During the process that the second door 16 is open and then closed, the locking device 22 can easily move into the space by moving along the inclined surface.

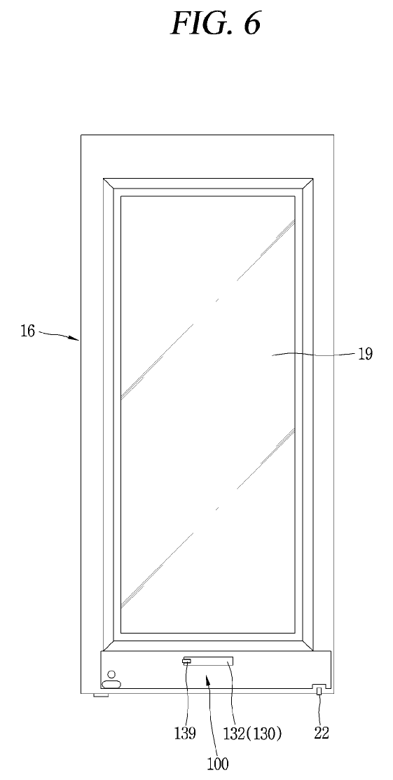

FIG. 6 is a conceptual view of a state in which a pusher 130 is mounted to a rear surface of the second door 16 in FIG. 2.

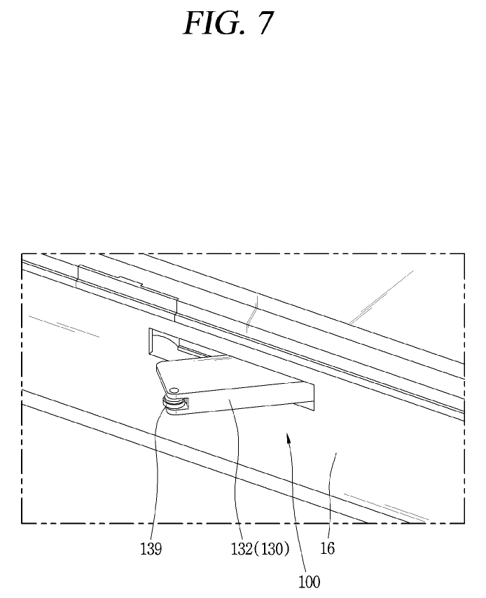

FIG. 7 is a conceptual view of a state in which the pusher 130 protrudes from the rear surface of the second door 16 in FIG. 6.

FIG. 8 is a conceptual view of a state in which a door opening device 100 is installed inside the second door 16 in FIG. 6.

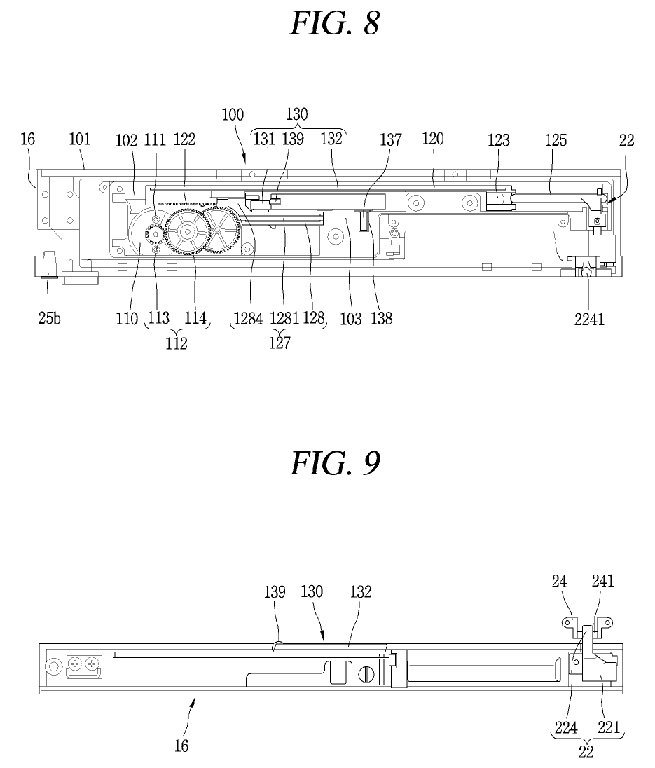

FIG. 9 is a conceptual view of the door opening device 100 in FIG. 8, viewed from the bottom.

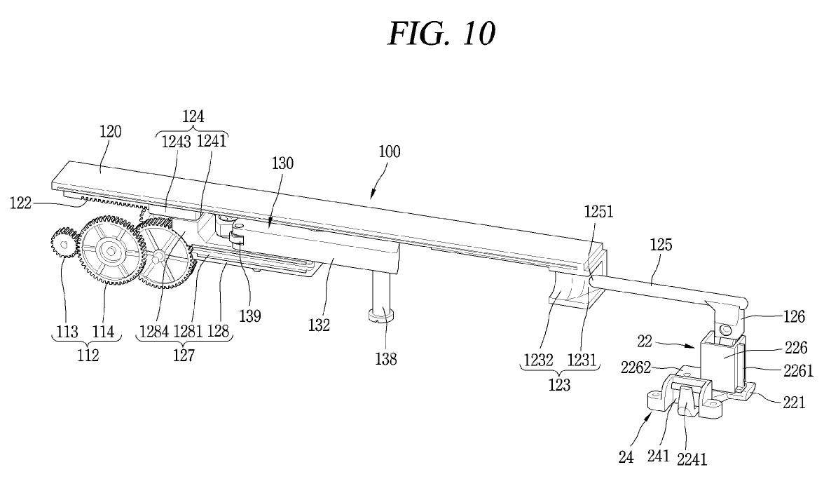

FIG. 10 is a perspective view of a locked state of the locking device 22 before operation of the door opening device 100 when the second door 16 is closed, viewed from the rear of the second door 16.

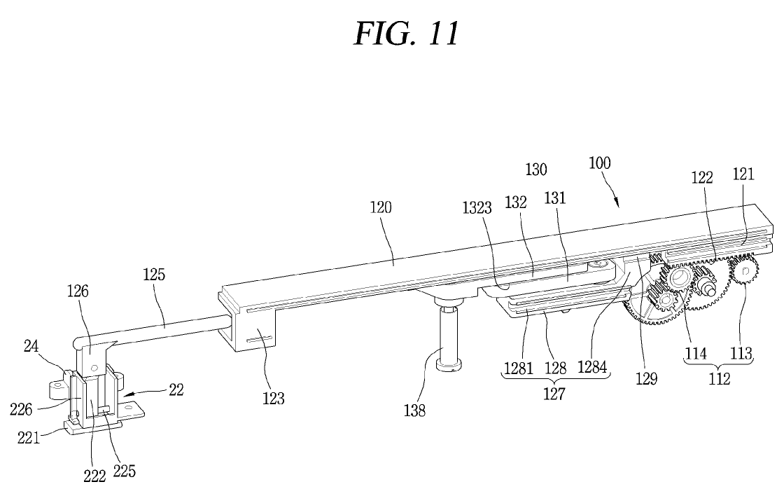

FIG. 11 is a perspective view of the locked state of the locking device 22 before operation of the door opening device 100 when the second door 16 is closed, viewed from the front of the second door 16.

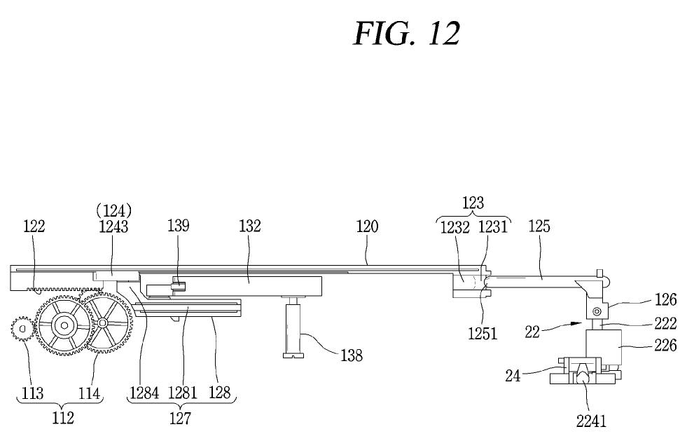

FIG. 12 is a conceptual view of the locked state of the locking device 11 before operation of the door opening device 100 when the second door 16 is closed, viewed from the rear of the second door 16.

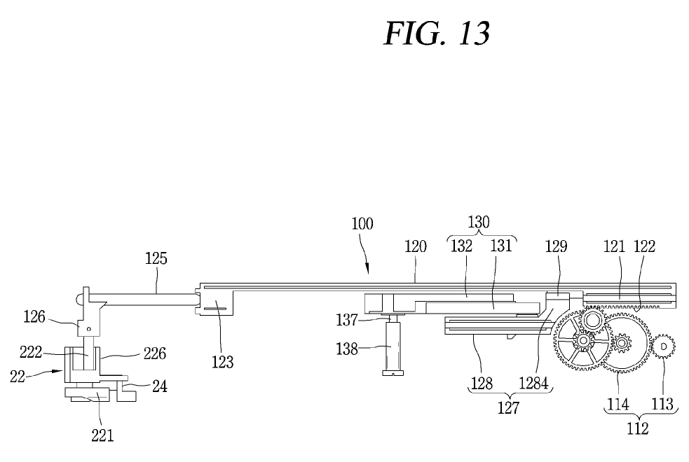

FIG. 13 is a conceptual view of the locked state of the locking device 22 before operation of the door opening device 100 when the second door 16 is closed, viewed from the front of the second door 16.

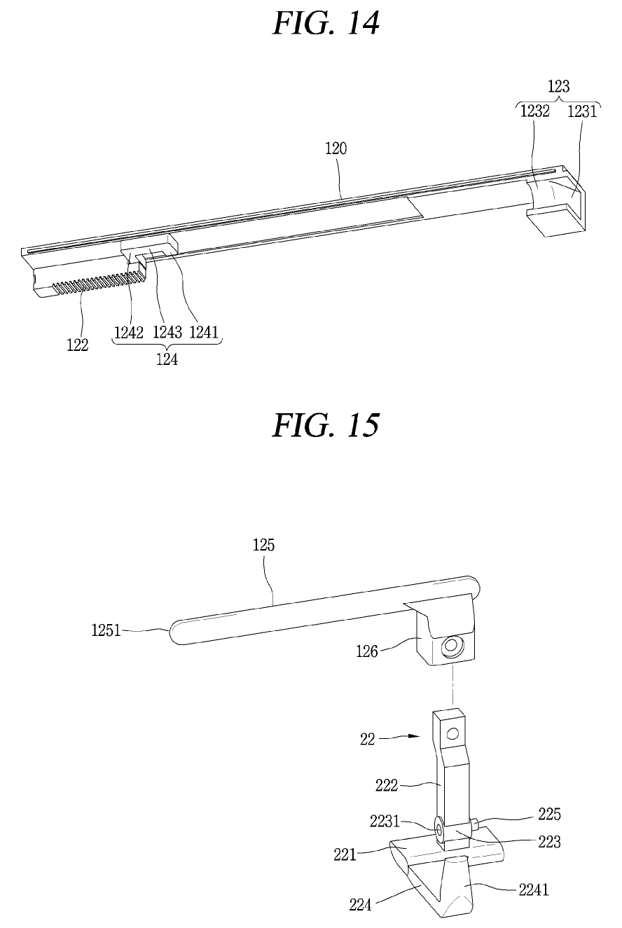

FIG. 14 is a conceptual view of a first rack 120 of FIG. 10, viewed from the bottom.

FIG. 15 is an exploded perspective view of a rotary bar 125 and the locking device 22 in FIG. 10.

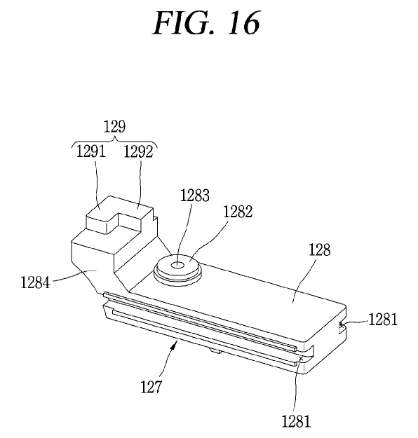

FIG. 16 is a conceptual view of a second rack 127 in FIG. 10.

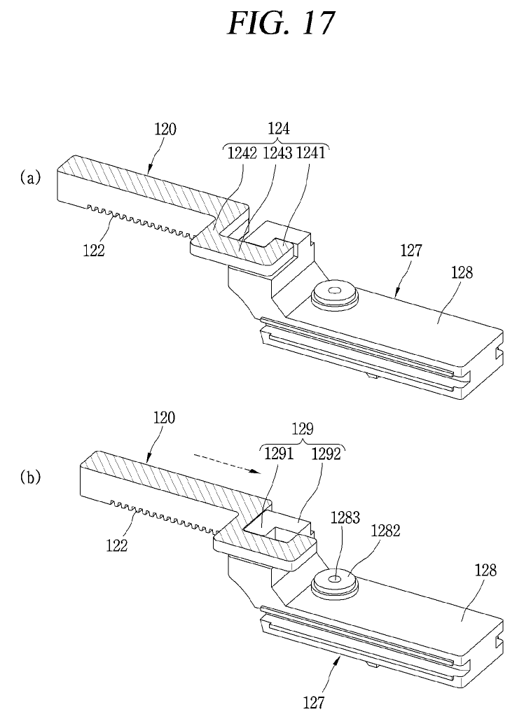

FIG. 17 is a conceptual view for explaining the operation of the second rack 127 according to the movement of the first rack 120 in FIG. 10.

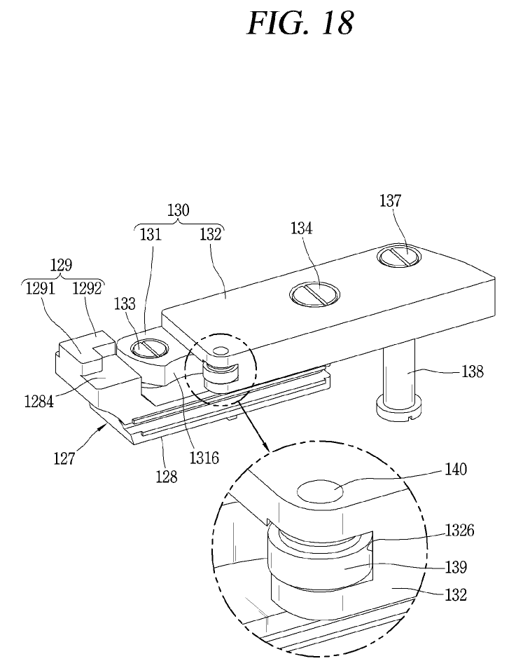

FIG. 18 is a perspective view for explaining the coupling relationship between the second rack 127 and the pusher 130 in FIG. 10.

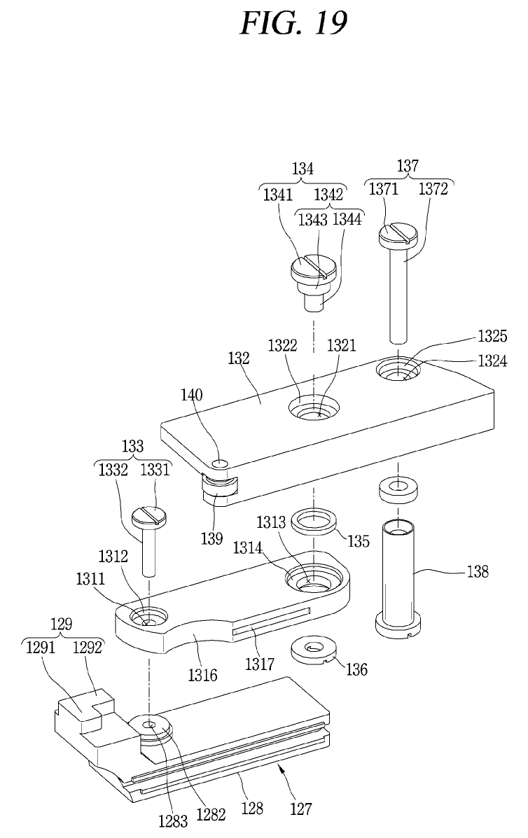

FIG. 19 is an exploded view of the second rack 127 and the pusher 130 in FIG. 18.

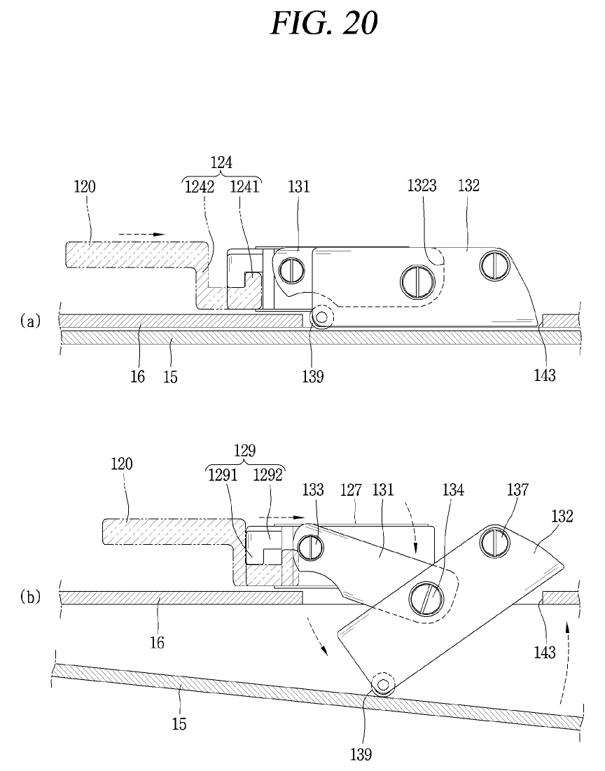

FIG. 20 is a conceptual view of an operating state of the pusher 130 according to the movement of the second rack 127 in FIG. 18.

The refrigerator includes a door opening device 100. The door opening device 100 is configured to automatically open the second door 16. The second door 16 may be rotatable relative to the first door 15 by the door opening device 100.

To open the second door 16, the first door 15 and the second door 16 must be unlocked first. The door opening device 100 is configured to operate the locking device 22 of the second door 16 to the unlock position.

For this purpose, the door opening device 100 may be arranged adjacent to the locking device 22. For example, the door opening device 100 may be installed on the second door 16. In this embodiment, the locking device 22 may be a separate component from the door opening device 100 or may be a component which constitutes the door opening device 100.

The door opening device 100 may include a driving unit 110. The driving unit 110 may include a motor. The motor may be configured to rotate in both directions.

The door opening device 100 may further include a case 101. The case 101 may be installed in a lower portion of the second door 16. The case 101 may be accommodated inside the second door 16. As another example, a portion of the case 101 may be omitted and a wall of the second door 16 may serve as the case 101.

This embodiment shows an example in which the case 101 is accommodated inside the second door 16.

The case 101 may be formed in a rectangular shape which is long in one direction. The case 101 may extend such that a length in a left-right direction of the second door 16 is greater than a height in an up-down direction and a width in a front-rear direction.

The case 101 may support the components constituting the door opening device 100, fix the positions of the components, or guide the movement of the components.

The driving unit 110 may be accommodated inside the case 101. A fastening portion 111 may protrude from one side of the driving unit 110. The driving unit 110 may be fastened to the case 101 by the fastening portion 111.

The door opening device 100 may further include a driving force transmission unit 112. The driving force transmission unit 112 may be accommodated inside the case 101. The driving force transmission unit 112 may include a plurality of gears, for example. Each of the plurality of gears may be rotatably installed in the case 101.

The plurality of gears includes a driving gear 113 and a driven gear 114. The driving gear 113 may be connected to a shaft of the motor. The driven gear 114 may be arranged as a plurality of gears 114. The driving gear 113 and the driven gear 114 may each be implemented as a pinion gear.

The driving gear 113 and the driven gear 114 may each be formed in a circular shape. The driving gear 113 and the driven gear 114 may have different diameters, and the number of teeth formed on an outer circumferential surface of each gear may be different. The plurality of driven gears 114 may have different diameters and different numbers of teeth.

At least one of the plurality of driven gears 114 may engage with the driving gear 113. At least one other of the plurality of driven gears 114 may engage with a rack gear 12 of a first rack 120, which will be described later.

Through this, the driving gear 113 and the driven gear 114 can reduce a rotational speed of the motor according to a preset gear ratio. Accordingly, the driving gear 113 and the driven gear 114 can increase a rotational torque of the motor.

The drive gear 113 and the driven gear 114 can generate a large rotational force even when the driving force of the motor is small, thereby reducing the size and power consumption of the motor.

The door opening device 100 may include a first rack 120. The first rack 120 may be installed in the case 101 to perform a linear reciprocating motion in one direction or an opposite direction. In this specification, a rack may be referred to as a moving member in that it can make a linear reciprocating motion in both directions. Here, both directions may mean, for example, left and right directions.

The first rack 120 may be formed in a rectangular shape. The first rack 120 may be formed such that a length in one direction is greater than a height in the up-down direction and a width in the front-rear direction. A first guide groove 121 may be formed concavely on at least one of front and rear surfaces of the first rack 120.

This embodiment shows an example in which the first guide groove 121 is formed concavely on the front surface of the first rack 120. The first guide groove 121 may extend along the left-right direction on the front surface of the first rack 120.

A first guide protrusion 102 may protrude from an inner surface of the case 101 in a direction of facing the first guide groove 121. The first guide protrusion 102 may extend in the left-right direction. The first guide protrusion 102 may be inserted into the first guide groove 121.

Through this, the first rack 120 can move left and right by being guided by the first guide protrusion 102.

A rack gear 122 may be formed on a lower surface of one end of the first rack 120. The rack gear 122 may extend in one direction, for example, in the left-right direction. The rack gear 122 may engage with the driven gear 114 described above.

Through this, the rack gear 122 can convert a rotational motion of the driven gear 114 into a linear motion.

The first rack 120 may perform a linear reciprocating motion by receiving the driving force from the driving unit 110 through the driving gear 113, the driven gear 114, and the rack gear 122.

A cam 123 may be formed on another end of the first rack 120. The cam 123 may be arranged in an opposite direction of the rack gear 122 based on a longitudinal direction of the first rack 120. The cam 123 may be arranged to face the locking device 22.

The cam 123 may be configured to convert a linear motion into a rotational motion or vice versa. This embodiment shows an example in which the cam 123 converts the linear motion of the first rack 120 into the rotational motion of the rotary bar 125 to be described later.

The cam 123 may be configured to transmit a driving force received from the first rack 120 to the locking device 22.

The cam 123 may be formed in a rectangular shape. The cam 123 may include a first contact surface 1231 and a second contact surface 1232.

The first contact surface 1231 may be arranged toward a rotary bar 125 to be described later. The first contact surface 1231 may be arranged to be contactable with one end of the rotary bar 125. The first contact surface 1231 may be inclined in the left-right direction with respect to the front-rear direction.

In case that the first rack 120 is located at a first position upon closing the second door 16, the first contact surface 1231 may be arranged to be in contact with one end of the rotary bar 125. Here, one end of the first contact surface 1231 may be arranged closer to the one end of the rotary bar 125 than another end of the first contact surface 1231.

For example, a front end of the first contact surface 1231 may be positioned closer to the rotary bar 125 than a rear end of the first contact surface 1231. The first contact surface 1231 may be inclined to be far away from the rotary bar 125 in a direction from the front end to rear end thereof.

That is, a distance between the rear end of the first contact surface 1231 and one end of the rotary bar 125 may be longer than a distance between the front end of the first contact surface 1231 and the one end of the rotary bar 125.

The front end of the first contact surface 1231 may be a starting point where a contact with the one end of the rotary bar 125 starts. The rear end of the first contact surface 1231 may be an ending point where the contact with the one end of the rotary bar 125 ends.

Through this, the first contact surface 1231 can induce a rotational motion of the rotary bar 125 in the front-rear direction between the starting points and the ending point of the contact with the rotary bar 125.

The second contact surface 1232 may form a rear surface of the cam 123. The second contact surface 1232 may have a semicircular or arcuate cross-sectional shape. The second contact surface 1232 may be formed to be concave forward on the rear surface of the cam 123.

The second contact surface 1232 may extend from the rear end of the first contact surface 1231 in one direction, for example, in the left-right direction. The second contact surface 1232 may be formed in a curved shape to be in surface contact with an outer circumferential surface of the rotary bar 125.

Through this, the rotary bar 125 can be accommodated in the second contact surface 1232 and can slide left and right in a surface contact state. In the contact state with the rotary bar 125, the second contact surface 1232 can support the rotary bar 125 so that the rotary bar 125 remains rotated in a rearward direction.

Here, the rearward direction is a direction toward the first door 15.

The rotary bar 125 may be formed in a cylindrical shape. The rotary bar 125 may extend in the left-right direction. A contact end 1251 may be formed on one end of the rotary bar 125. The contact end 1251 of the rotary bar 125 may be arranged toward the first contact surface 1231.

The contact end 1251 may be formed in a spherical shape. Accordingly, the contact end 1251 can minimize wear due to friction with the first contact surface 1231.

The contact end 1251 of the rotary bar 125 may rotate by receiving the driving force through the movement of the cam 123 while being in contact with the first contact surface 1231 and the second contact surface 1232.

A coupling portion 126 may be formed on another end of the rotary bar 125. The coupling portion 126 may extend downward from the other end of the rotary bar 125 toward the locking device 22. A coupling hole 1261 may be formed through the coupling portion 126 in the front-rear direction.

A coupling space may be formed inside the coupling portion 126 so that the upper end of the locking device 22 can be inserted. The coupling portion 126 of the rotary bar 125 may be fitted to surround the upper end of the locking device 22.

The locking device 22 may include a latch bar 222 and a latch 224. The latch bar 222 may extend in the up-down direction. The upper end of the latch bar 222 may be inserted into the coupling portion 126 of the rotary bar 125. A fastening hole 2221 may be formed through the upper end of the latch bar 222 in the front-rear direction.

The fastening hole 2221 may be arranged to overlap the coupling hole 1261 of the coupling portion 126 in the front-rear direction. Through this, a fastening member, such as a screw, may be coupled to the coupling portion 126 and the latch bar 222 through the coupling hole 1261 and the fastening hole 2221. The latch bar 222 of the locking device 22 and the rotary bar 125 can be fastened by the fastening member.

A boss portion 223 may be formed on a lower portion of the latch bar 222. A hinge pin accommodating hole 2231 may be formed inside the boss portion 223 in the left-right direction. A hinge pin 225 may be rotatably coupled to a supporter 226, which will be described later, through the hinge pin accommodating hole 2231.

The supporter 226 may be installed in a lower portion of the second door 16. The supporter 226 may be arranged in a left end or a right end of the second door 16. When the second door 16 is located on the right side of the cabinet 10, the supporter 226 may be arranged in the left end of the second door 16. When the second door 16 is located on the left side of the cabinet 10, the supporter 226 may be arranged in the right end of the second door 16.

The supporter 226 may be configured to surround at least one surface of the latch bar 222. This embodiment shows an example in which the supporter 226 surrounds a left surface, a right surface, and a rear surface of the latch bar 222.

A coupling protrusion 2261 may protrude from a right surface of the supporter 226. Accordingly, the coupling protrusion 2261 can be coupled to the second door 16.

A fastening plate 2262 may protrude from a right surface of the supporter 226. A fastening hole may be formed through the fastening plate 2262 in the up-down direction. The fastening plate 2262 may be fastened to the second door 16 by a fastening member, such as a screw, which is inserted through the fastening hole.

The hinge pin 225 may be rotatably mounted between the left and right surfaces of the supporter 226. The hinge pin 225 may support the latch bar 222 so that the latch bar 222 can rotate in the front-rear direction.

The latch 224 may be arranged on a lower end of the latch bar 222. The latch 224 may extend from the lower end of the latch bar 222 in the front-rear direction. For example, the latch 224 may protrude rearward from the lower end of the latch bar 222 toward the lower end of the first door 15.

A latch hook 2241 may protrude from a rear end of the latch 224. The latch hook 2241 may rotate forward and backward together with the latch 224 to be locked or unlocked by being caught on the engaging portion 24 of the first door 15.

An operating unit 221 may be arranged on the lower end of the latch bar 222. The operating unit 221 may extend from the lower end of the latch bar 222 in the front-rear direction. For example, the operating unit 221 may protrude forward in an opposite direction to the latch 224 based on the latch bar 222 to be exposed to the front of the second door 16.

Through this, the operating unit 24 can be manually operated by the user.

A length between the rotary bar 125 and the hinge pin 225 along the length of the latch bar 222 may be longer than a length between the latch 224 and the hinge pin 225.

Through this, a rotation angle of the rotary bar 125 can be greater than a rotation angle of the latch 224 based on the hinge pin 225.

The locking device 22 may be locked or unlocked automatically or manually.

For example, the locking device 22 may be automatically unlocked.

The latch bar 222 may rotate forward and backward around the hinge pin 225 by receiving a driving force from the rotary bar 125.

The upper end of the latch bar 222 may rotate rearward toward the first door 15, while the lower end of the latch bar 222 may rotate forward toward the front surface of the second door 16. The latch 224 located on the lower end of the latch bar 222 rotates forward.

The latch hook 2241 may rotate from a lock position thereof to an unlock position. The unlock position may be located lower than the lock position.

The door opening device 100 includes a second rack 127 and a pusher 130 to open the second door 16.

The second rack 127 is installed to be movable left and right inside the case 101. The second rack 127 is configured to transmit a driving force received from the first rack 120 to the pusher 130.

The second rack 127 may include a body 128 and an extension portion 1284. The body 128 of the second rack 127 may be formed in a rectangular shape. The body 128 may extend in the left-right direction. A second guide groove 1281 may be formed concavely in the front-rear direction on at least one of front and rear surfaces of the body 128. This embodiment shows an example in which the second guide groove 1281 is concavely formed on each of the front and rear surfaces of the body 128. The second guide grooves 1281 may extend in the left-right direction along the front and rear surfaces of the body 18.

A second guide protrusion 103 may protrude in the front-rear direction from the inner surface of the case 101 toward the second guide groove 1281. The second guide protrusion 103 may extend in the left-right direction. The second guide protrusion 103 may be inserted into the second guide groove 1281. Through this, the second rack 127 can slide left and right along the second guide protrusion 103.

The extension portion 1284 may protrude upward from one end of the body 128. The extension portion 1284 may be arranged below one end of the first rack 10. An operating protrusion 129 may protrude upward from an upper surface of the extension portion 1284 toward the first rack 120.

The operating protrusion 129 may include a first part 1291 and a second part 1292. The first part 1291 may extend in the front-rear direction. The second part 1292 may be connected to one side surface of the first part 1291 and may extend in the left-right direction crossing the first part 1291.

The first part 1291 of the operating protrusion 129 may be connected in contact with a contact portion 124 of the first rack 120 to be described later. Accordingly, the operating protrusion 129 can transmit the driving force of the first rack 120 to the second rack 127.

The second part 1292 of the operating protrusion 129 can expand an upper area of the extension portion 1284, which supports the operating protrusion 129, thereby reinforcing the strength of the operating protrusion 129. In case that there is no problem with the support strength of the operating protrusion 129, the second part 1292 may be omitted.

The second part 1292 may guide the movement of the first rack 120 when being brought into contact with a first contact protrusion 1241 of the first rack 120 to be described later.

The first rack 120 may include the contact portion 124. The contact portion 124 may protrude downward from the lower surface of the first rack 120 toward the second rack 127. The contact portion 124 may include a first contact protrusion 1241, a second contact protrusion 1242, and a connection protrusion 1243.

The first contact protrusion 1241 may extend in a direction crossing the first rack 120. For example, the first contact protrusion 1241 may extend in the front-rear direction from the lower surface of the first rack 120.

A length of the first contact protrusion 1241 in the front-rear direction may be equal to or smaller than a width of the first rack 120 in the front-rear direction. This embodiment shows an example in which the length of the first contact protrusion 1241 in the front-rear direction is smaller than the width of the first rack 120 in the front-rear direction.

The first contact protrusion 1241 may be selectively brought into contact with the operating protrusion 129 depending on the change in position of the first rack 120. For example, when the first rack 120 is located at a first position, the first contact protrusion 1241 may be brought into contact with the operating protrusion 129. When the first rack 120 is located at a second position, the first contact protrusion 1241 and the operating protrusion 129 may be spaced apart from each other.

Here, the first position defines a position at which the first rack 120 can move as close as possible toward the hinge when the first door 15 is closed. The second position defines a position at which the first rack 120 can move as close as possible toward the locking device 22 when the second door 16 is open.

The second contact protrusion 1242 may extend in a direction crossing the first rack 120. For example, the second contact protrusion 1242 may extend in the front-rear direction from the lower surface of the first rack 120. The second contact protrusion 1242 may extend rearward from one end of the rack gear 122.

A length of the second contact protrusion 1242 in the front-rear direction may be equal to or smaller than a width of the first rack 120 in the front-rear direction. This embodiment shows an example in which the length of the second contact protrusion 1242 in the front-rear direction is equal to the width of the first rack 120 in the front-rear direction.

The second contact protrusion 1242 may be arranged at a preset distance from the first contact protrusion 1241 in the left-right direction.

The connection protrusion 1243 may be arranged between the first contact protrusion 1241 and the second contact protrusion 1242. The connection protrusion 1243 may extend in the left-right direction. One end of the connection protrusion 1243 may be connected to one end of the first contact protrusion 1241, and another end of the connection protrusion 1243 may be connected to one end of the second contact protrusion 1242.

Through this, the connection protrusion 1243 can connect the first contact protrusion 1241 and the second contact protrusion 1242. The connection protrusion 1243 can secure the support force and rigidity of the first contact protrusion 1241 and the second contact protrusion 1242. The connection protrusion 1243 may guide the movement of the operating protrusion 129 in the left-right direction.

The operating protrusion 1241 may be arranged between the first contact protrusion 1241 and the second contact protrusion 1242. A gap between the first contact protrusion 1241 and the second contact protrusion 1242 may be larger than a width of the first part 1291 of the operating protrusion 129 in the left-right direction.

The second contact protrusion 1242 may be selectively brought into contact with the operating protrusion 129 depending on the change in position of the first rack 120. For example, when the first rack 120 is located at a second position, the second contact protrusion 1242 may be brought into contact with the operating protrusion 129. When the first rack 120 is located at a first position, the second contact protrusion 1242 and the operating protrusion 129 may be spaced apart from each other.

The first contact protrusion 1241 and the second contact protrusion 1242 may be selectively brought into contact with the operating protrusion 129 depending on the movement direction of the first rack 120.

For example, when the first rack 120 moves in one direction toward the locking device 22 to open the second door 16, the second contact protrusion 1242 and the operating protrusion 129 may be brought into contact with each other. When the second contact protrusion 1242 and the operating protrusion 129 begin to come into contact with each other, the driving force of the first rack 120 may be transmitted to the second rack 127.

The first rack 120 may move further in the one direction to reach the second position after the second contact protrusion 1242 and the operating protrusion 129 come into contact with each other.

The second rack 127 may move in the one direction by receiving the driving force from the first rack 120 through the contact between the second contact protrusion 1242 and the operating protrusion 129. The second rack 127 may transmit the driving force of the first rack 120 to the pusher 130 to be described later.

A pusher outlet 143 may be formed in the front surface of the second door 16. The pusher outlet 143 is formed through the second door 16 in the front-rear direction. The pusher 130 may be pulled out toward the first door 15 through the pusher outlet 143.

The pusher 130 is configured to apply pushing force the first door 15 by the operation of the door opening device 100. The pusher 130 may be exposed from the rear surface of the second door 16 toward the first door 15. A portion of the pusher 130 may be arranged to be in contact with the front surface of the first door 15.

The pusher 130 may rotate toward the first door 15 while being in contact with the first door 15 when the second door 16 is open, thereby applying pushing force the front surface of the first door 15.

Through this, the second door 16 can be open by a reactive force of the first door 15 against the applying pushing force of the pusher 130 applied to the first door 15.

The pusher 130 may receive the driving force of the driving unit 110 through the second rack 127.

The pusher 130 may include a link 131 and a second link 132. The first link 131 may be rotatably mounted on the body 128 of the second rack 127.

The first link 131 may be formed in a rectangular shape. Upper and lower surfaces of the first link 131 may each be formed flat. A thickness of the first link 131 may be defined between the upper and lower surfaces of the first link 131.

The first link 131 may extend in the left-right direction. Left and right surfaces of the first link 131 may each be formed in a curved shape. The right surface of the first link 131 may be arranged toward the extension portion 1284 of the second rack 127. The left surface of the first link 131 may be arranged in a direction away from the extension portion 1284 of the second rack 127.

Front and rear surfaces of the first link 131 may each be formed in a planar shape. The front surface of the first link 131 may be arranged toward the front surface of the second door 16. The rear surface of the second link 131 may be arranged toward the front surface of the first door 15.

A length of the first link 131 in the left-right direction may be greater than a width of the first link 131 in the front-rear direction and the thickness of the first link 131. The thickness of the first wall 131 may be smaller than the width of the first link 131 in the front-rear direction.

The first link 131 may be rotatably mounted on the body 128 of the second rack 127 by a first coupling pin 133. The first coupling pin 133 may include a first head portion 1331 and a first stem portion 1332. The first stem portion 1332 may be formed in a cylindrical shape. The first stem portion 1332 may extend in the up-down direction. A screw portion 1344 may be formed on one end of the first stem portion 1332.

The first head portion 1331 may be formed with a large diameter on another end of the stem portion 1332. A linear groove may be formed on one surface of the first head portion 1331. The linear groove may be connected to an electric tool, and thus a rotational force of the electric tool may be transmitted to a head portion through the linear groove.

However, the linear groove is not limited to the shape, and may be formed in various shapes, such as a cross shape and a square shape. This embodiment shows an example in which the first head portion 1331 is formed in a circular shape, but in case that the first head portion 1331 is formed in a hexagonal or square shape, the linear groove may be omitted.

A lower surface of the first link 131 may be arranged to face the upper surface of the body 128 of the second rack 127. The first link 131 may be arranged to overlap the body 128 of the second rack 127 in the up-down direction. Here, the fact that the link 131 and the body 128 of the second rack 127 are arranged to overlap each other in the up-down direction means that a longitudinal center line of the first link 131 and a longitudinal center line of the second rack 127 are arranged to overlap each other in the up-down direction.

A first coupling hole 1283 may be formed through one side of the body 128 in the up-down direction. A mounting portion 1282 may protrude upward from one side of the upper surface of the body 128. The mounting portion 1282 may be formed in a circular shape. The mounting portion 1282 is formed to surround the first coupling hole 1283. The mounting portion 1282 may be formed in a planar shape.

Through this, the mounting portion 1282 can protrude upward from the body 128 of the second rack 127, thereby reducing the contact area between the body 128 of the second rack 127 and the first link 131. When one end of the first link 131 rotates while being seated on the mounting portion 1282, the frictional area and frictional resistance between the body 128 of the second rack 127 and the first link 131 can be minimized.

A first pin accommodating hole 1311 may be formed through one end of the first link 131 in the up-down direction. A first head portion accommodating groove 1312 may be formed on one end of the first link 131 to surround the first pin accommodating hole 1311.

The first head portion 1331 may be accommodated in the first head portion accommodating groove 1312. The first stem portion 1332 may be accommodated in the first pin accommodating hole 1311. The first pin accommodating hole 1311 may be arranged to overlap an upper portion of the first coupling hole 1283 in the up-down direction.

The first coupling pin 133 may be coupled to the first link 131 and the body 128 of the second rack 127 through the first pin accommodating hole 1311 and the first coupling hole 1283.

One end of the first link 131 may be coupled by a hinge to the upper surface of the body 128 of the second rack 127 by the first coupling pin 133. Another end of the first link 131 may rotate in the front-rear direction with respect to the second rack 127 around the first coupling pin 133.

For example, the first link 131 may rotate rearward toward the front surface of the first door 15 with respect to the second rack 127 when the second door 16 is open, or may return to its original position by rotating toward the front surface of the second door 16 to overlap the body 128 of the second rack 127 in the up-down direction when the second door 16 is closed.

The first link 131 may rotate in a rotation angle range of 0 to 45 degrees. Here, when the rotation angle of the first link 131 is 0 degree, it means that the first link 131 and the body 128 of the second rack 127 overlap each other in the up-down direction. When the rotation angle of the first link 131 is 45 degrees, it refers to an angle at which the first link 131 has rotated toward the first door 15 with respect to the body 128 of the second rack 127.

The first link 131 may move in the left-right direction along the second rack 127. The first link 131 may move linearly in the left-right direction and rotate at the same time.

Another end of the first link 131 may be connected to the second link 132 by the second coupling pin 134. The second coupling pin 134 may include a second head portion 1341 and a second stem portion 1342. The second head portion 1341 may protrude from an upper end of the second stem portion 1342 to have a large diameter in a radial direction. A linear groove may be formed on an upper surface of the second head portion 1341. A connecting groove for connecting an electric tool and the second head portion 1341 is not limited to the linear groove and may be formed in various shapes, for example, a cross groove.

The second stem portion 1342 may include a shaft 1343 and a screw portion 1344. The shaft 1343 may be formed in a cylindrical shape. A diameter of the shaft 1343 is smaller than the diameter of the second head portion 1341. The shaft 1343 may serve as a rotational shaft of the second link 132.

The screw portion 1344 may be formed in a cylindrical shape. A male thread may be formed on an outer circumferential surface of the screw portion 1344. The screw portion 1344 may be fastened to a nut 136 to be explained later.

A second pin accommodating hole 1313 may be formed through the other end the first link 131 in the up-down direction. A first accommodating groove 1314 may be recessed downward on an upper side of the other end of the first link 131. A washer 135 may be accommodated in the first accommodating groove 1314. The washer 135 surrounds the shaft 1343 of the second stem portion 1342.

A second accommodating groove (not shown) may be recessed upward on a lower side of the other end of the first link 131. The nut 136 may be accommodated in the second accommodating groove. The nut 136 may be formed in a circular shape. A linear groove may be formed on a lower surface of the nut 136. The linear groove may be connected to an electric tool or a manual tool, such as a cross-head screw driver.

A female thread may be formed on an inner circumferential surface of the nut 136. Through this, the screw portion 1344 of the second stem portion 1342 may be fastened to the nut 136.

The second link 132 may be formed in a rectangular shape. Upper and lower surfaces of the second link 132 may each be formed in a planar shape. A thickness of the second link 132 may be defined between the upper and lower surfaces of the second link 132.

The second link 132 may extend in the left-right direction. A right surface of the second link 132 may be arranged toward the operating protrusion 129. The right surface of the second link 132 may be formed in a planar shape. The right surface of the second link 132 may be arranged in an opposite direction to the operating protrusion 129.

The right surface of the second link 132 may be inclined to the right with respect to the front-rear direction. A length of the second link 132 in the left-right direction may increase from front end to rear end on the right surface of the second link 132.

At least a portion of the second link 132 overlaps a portion of the first link 131 in the up-down direction. A second coupling hole 1321 may be formed in the up-down direction through the longitudinal center of the second link 132.

The second head portion accommodating groove 1322 may be recessed downward on the upper surface of the second link 132 so that the second head portion 1341 of the second coupling pin 134 is accommodated. The second head portion accommodating groove 1322 surrounds the second coupling hole 1321.

The second pin accommodating hole 1313 and the second coupling hole 1321 may be arranged to overlap each other in the up-down direction.

The second coupling pin 134 may be fastened to the nut 136 by penetrating the second link 132 and the first link 131 through the second coupling hole 1321 and the second pin accommodating hole 1313. Through this, the other end of the first link 131 and the one end of the second link 132 can be coupled to each other to be rotatable relative to each other by the second coupling pin 134.

A link accommodating portion 1323 may be formed on the lower surface of the second link 132. The first link 131 may be accommodated in the link accommodating portion 1323. The link accommodating portion 1323 may be recessed on the lower surface of the second link 132 toward the upper surface of the second link 132.

The link accommodating portion 1323 may extend from the right surface of the second link 132 toward the left surface of the second link 132. The link accommodating portion 1323 may extend from the front surface of the second link 132 toward the rear surface of the second link 132.

When the first link 131 is accommodated in the link accommodating portion 1323 so that the first link 131 and the second link 132 are arranged to overlap each other in the up-down direction, the second link 132 may surround the upper surface, rear surface, and right surface of the first link 131.

The second coupling hole 1321 may communicate with the link accommodating portion 1323 in the up-down direction.

Another portion of the first link 131 where the first pin accommodating hole 1311 is formed may be arranged outside the second link 132.

The second link 132 may be rotatably installed inside the case 101 by a third coupling pin 137. The third coupling pin 137 may include a third head portion 1371 and a third stem portion 1372. The third head portion 1371 protrudes radially outward from an upper end of the third stem portion 1372.

The third stem portion 1372 may be formed in a cylindrical shape. The third stem portion 1372 may extend in the up-down direction.

A third coupling hole 1324 may be formed through the other end the second link 132 in the up-down direction. A third head portion accommodating groove 1325 may be recessed downward on the other end of the second link 132. The third head portion accommodating groove 1325 surrounds the third coupling hole 1324. The third head portion accommodating groove 1325 may be connected to the third coupling hole 1324 in communication.

A pin boss portion 138 may be fixedly installed inside the case 101. A fastening hole may be formed inside the pin boss portion 138. The pin boss portion 138 may be coupled to the third stem portion 1372 of the third coupling pin 137 through the fastening hole.

The third coupling pin 137 may be fastened to the pin boss portion 138 by passing through the third coupling hole 1324. Accordingly, the second link 132 can rotated around the third coupling pin 137.

When the body 128 of the second rack 127, the first link 131, and the second link 132 are arranged to overlap one another in the up-down direction, the front surface of the body 128 of the second rack 127, the front surface of the first link 131, and the front surface of the second link 132 may form the same plane in the up-down direction.

The center of the first coupling pin 133 of the first link 131 may be spaced apart from the front surface of the first link 131 by a distance d1. The center of the second coupling pin 134 of the first link 131 may be spaced apart from the front surface of the first link 131 by a distance d2.

The other end of the first link 131 and the one end of the second link 132 are coupled by sharing the second coupling pin 134. The center of the second coupling pin 134 of the first link 131 and the second link 132 may be spaced apart from the front surfaces of the first link 131 and the second link 132 by the distance d2.

The center of the third coupling pin 137 of the second link 132 may be spaced apart from the front surface of the second link 132 by a distance d3. Here, the distances d1, d2, and d3 may be different. Comparing the d1, d2, and d3, d2>d1>d3 may be obtained.

When the body 128 of the second rack 127 and the first link 131 are arranged to overlap each other in the up-down direction, the distance between the front surface of the first link 131 and the center of the second coupling pin 134 of the first link 131 is greater than the distance between the front surface of the first link 131 and the center of the first coupling pin 133 of the first link 131.

Accordingly, the first link 131 can convert the linear motion of the second rack 127 into the rotational motion of the second link 132. A driving force which is applied to the right at the first coupling pin 133 of the first link 131 may be converted into a moment or torque at the second coupling pin 134 of the first link 131.

While the first link 131 moves to the right toward the third coupling pin 137, the second coupling pin 134 of the first link 131 may rotate clockwise around the first coupling pin 133.

The first link 131 and the second link 132 may have the first coupling pin 133 and the second coupling pin 134 which serve as different rotation axes, and may be connected to each other via the second coupling pin 134 so as to rotate in opposite directions.

For example, as the first link 131 rotates clockwise around the first coupling pin 133, the second link 132 can rotate counterclockwise around the third coupling pin 137.

The second link 132 may rotate forward and backward in an angle range of 0 to 45 degrees.

The second link 132, which is connected to the other end of the first link 131 through the second coupling pin 134, may apply pushing force the first door 15. Accordingly, the pusher 130 can apply pushing force the first door 15, and the second door 16 can be open by the reactive force of the first door 15 against the applying pushing force of the pusher 130.

However, when the second door 16 is open, there is a problem in that the pusher 130 is scratched or worn due to friction with the first door 15 during rotation in the contact state with the front surface of the first door 15.

To address this problem, the pusher 130 may include a rotary wheel 139.

The rotary wheel 139 may be rotatably mounted on one corner of the second link 132 by a central shaft 140. Here, the one corner of the second link 132 may mean a corner where the rear and right surfaces of the second link 132 are connected to each other.

A wheel mounting portion 1326 is formed concavely on one corner of the second link 132. The rotary wheel 139 may be accommodated and mounted inside the wheel mounting portion 1326.

The rotary wheel 139 may be formed in a circular shape. The rotary wheel 139 may be made of a material with excellent wear resistance, such as urethane.

The central shaft 140 may be formed in a cylindrical shape. The central shaft 140 may extend in the up-down direction.

When looking at the second link 132 from above, the central shaft 140 of the rotary wheel 139 may be placed at one corner of the second link 132, which is diagonally opposite to the third coupling pin 137 with respect to the second coupling pin 134.

A through hole may be formed through the one corner of the second link 132 in the up-down direction. A shaft accommodating hole may be formed through a central portion of the rotary wheel 139 in the up-down direction.

The central shaft 140 may be coupled through the second link 132 and the rotary wheel 139 through the through hole and the shaft accommodating hole.

The rotary wheel 139 may rotate relative to the second link 132. The rotary wheel 139 may rotate around the central shaft 140. The rotary wheel 139 may revolve around the third coupling pin 137.

When the second link 132 rotates during opening of the second door 16, the rotary wheel 139 may rotate in contact along a contact surface with the first door 15. Through this, the rotary wheel 139 can suppress scratches or wear due to friction between the pusher 130 and the first door 15 even when the second door 16 is open by physical contact by applying pushing force the first door 15.

A wheel accommodating groove 1316 may be formed concavely on a rear surface of one end of the first link 131 toward a front surface of the one end of the first link 131. The wheel accommodating groove 1316 is configured to accommodate a portion of the rotary wheel 139. The wheel accommodating groove 1316 may be formed in a curved shape on one side of the rear surface of the first link 131 toward the first pin accommodating hole 1311. The wheel accommodating groove 1316 may be spaced apart from the rotary wheel 139 with a gap therebetween.

Through this, the first link 131 can accommodate the portion of the rotary wheel 139 in the wheel accommodating groove 1316, such that the rotary wheel 139 and the first link 131 can rotate relative to each other without interference even though the first link 131 and the second link 132 are arranged to overlap each other in the up-down direction.

In order for the pusher 130 to apply pushing force the first door 15, when the first link 131 and the second link 132 rotate relative to each other, protrude toward the first door 15 from the body 128 of the second rack 127, and then return to their original positions, for example, when the first link and the second link 132 are arranged to overlap each other in the up-down direction on the body 128 of the second rack 127, the second link 132 and the first link 131 may collide with each other.

When the first link 131 and the second link 132 return to their original positions, the first link 131 may be accommodated in the link accommodating portion 1323 of the second link 132.

To solve this problem, a buffer protrusion 1317 may be arranged on the rear surface of the first link 131. A buffer protrusion 1317 may protrude rearward from the rear surface of the first link 131 toward the rear surface of the second link 132. The buffer protrusion 1317 may extend in the left-right direction along the rear surface of the first link 131.

Through this, the buffer protrusion 1317 can alleviate an impact caused by the mutual collision between the first link 131 and the second link 132 when the first link 131 and the second link 132 return to their original positions.

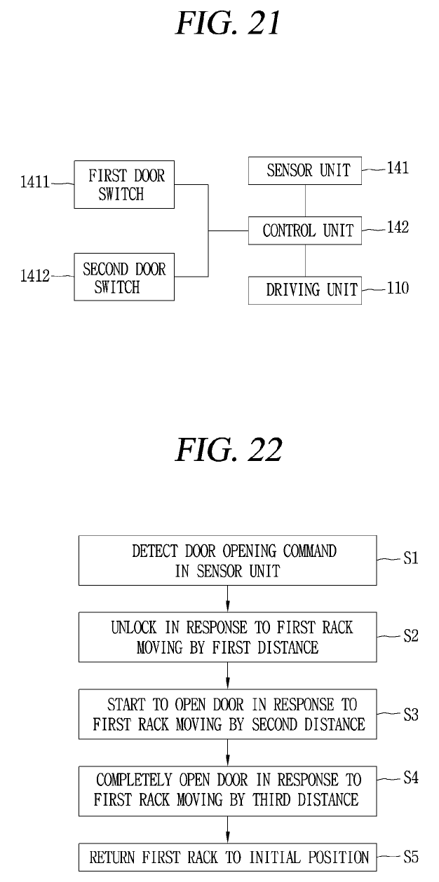

FIG. 21 is a block diagram of a configuration for controlling the opening of the second door 16 of the refrigerator according to an embodiment.

FIG. 22 is a flowchart of sequential operations of the door opening device 100 and the locking device 22 according to a movement distance of the first rack 120 according to an embodiment.

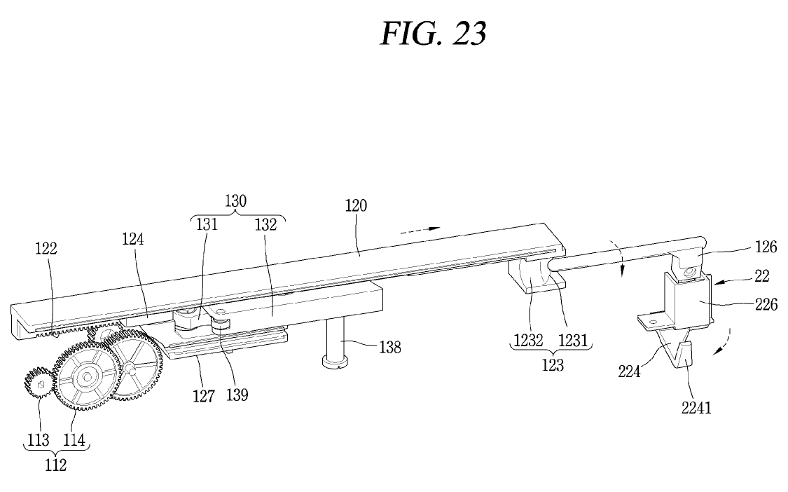

FIG. 23 is a conceptual view of a state in which the locking device 22 has been rotated to an unlocked state in response to the first rack 120 being moved by a first distance in FIG. 10.

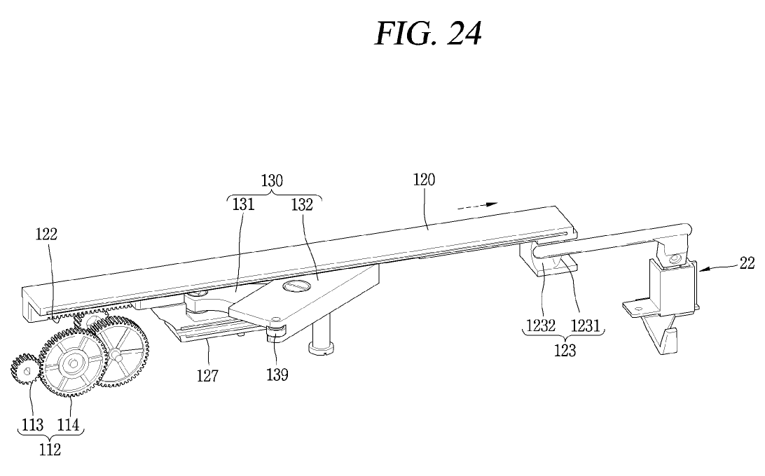

FIG. 24 is a conceptual view of a state in which the pusher 130 has been rotated to protrude from the second door 16 after the locking device 22 is unlocked, in response to the first rack 120 being moved by a third distance in FIG. 10.

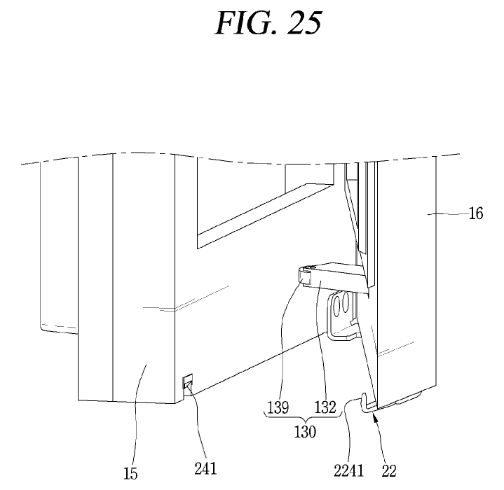

FIG. 25 is a conceptual view of a state in which the second door 16 is open by the pusher 130 pushing the front surface of the first door 15 in FIG. 24.

The refrigerator according to this embodiment may further include a control unit 142. The control unit 142 may be installed on or to be spaced apart from an object to be controlled. The control unit 142 may be located inside or outside the object to be controlled.

For example, the control unit 142 may be installed in the cabinet 10 or the refrigerating chamber door 13.

The control unit 142 may control the driving unit 110. The control unit 142 may be located outside the driving unit 110. The control unit 142 may control the driving unit 110 alone, or may control other components in the refrigerator in addition to the driving unit 110.

The second door 16 may include a sensor unit 141. The sensor unit 141 may detect an input of a door opening command for opening the second door 16. The sensor unit 141 may be implemented as any one sensor selected from a touch sensor, a knock sensor, a capacitive sensor, a vibration sensor, and a sound wave detection sensor. The touch sensor may be configured to detect that a user makes contact with a portion of his/her body, such as a hand, on the front surface of the second door 16. The knock sensor may be configured to detect knocks applied a plurality of times to the front surface of the second door 16. The sensor unit 141 may include a mechanical switch or a switch that operates by pressure.

As another example, the sensor unit 141 may be arranged on the cabinet 10, the first door 15, or the freezing chamber door 14.

The second door 16 may be open by a manual operation.

Even though the sensor unit 141 does not detect an input of a door opening command, the user may operate the locking device 22 to manually open the second door 16.

The locking device 22 may operate independently when the first rack 120 is positioned at the first position. Accordingly, when the user applies pushing force the operating unit 24 of the locking device 22 in one direction, for example, upward, the locking device 22 rotates in an unlocking direction. Through this, the locking device 22 can move from the lock position to the unlock position.

Hereinafter, an automatic opening operation mode of the second door 16 will be described.

The second door 16 may be open automatically.

In the closed and locked state of the first door 15 and the second door 16, when a door opening command is detected by the sensor unit 141 (S1), the control unit 142 may control the driving unit 110 to automatically open the second door 16.

In this embodiment, the operation of the driving unit 110 for opening the second door 16 may be performed while the first door 15 is closed. The opening and closing of the first door 15 may be detected by a first door switch 1411. The first door switch 1411 may be arranged on the cabinet 10 or the first door 15.

The operation of the driving unit 110 for opening the second door 16 may be performed while the second door 16 is closed. The opening and closing of the second door 16 may be detected by a second door switch 1412. The second door switch 1412 may be arranged on the first door 15 or the second door 16.

The control unit 142 may rotate the motor of the driving unit 110 in one direction (for example, clockwise). When the motor rotates in the one direction, the driving force of the driving unit 110 may be transmitted to the first rack 120 through the driving force transmission unit 112.

More specifically, the driving force of the motor of the driving unit 110 is transmitted to the driving gear 113 connected to the rotary shaft of the motor. As the driving gear 113 rotates, the plurality of driven gears 114 engaged with the driving gear 113 also rotate.

The rotation speed of the motor is reduced by a gear ratio between the driving gear 113 and the driven gears 114, but a torque generated in the motor increases. Among the plurality of driven gears 114, one driven gear 114 which ultimately transmits the driving force may engage with the rack gear 122 of the first rack 120, so that the torque can be transmitted to the rack gear 122 through the driven gear 114.

The driven gear 114 includes gear teeth which are formed along a circumferential direction on an outer circumferential surface of the pinion gear. The rack gear 122 includes gear teeth which are continuously formed along a horizontal direction. The gear teeth of the rack gear 122 engage with the gear teeth on the upper side of the driven gears 114.

Through this, the rotational motion of the driven gear 114 is converted into the linear motion of the rack gear 122, and the first rack 120 moves linearly from a first position toward the locking device 22 together with the rack gear 122. Here, the first position means a position of the first rack 120 when the second door 16 is closed and the first door 15 and the second door 16 are locked.

Next, the first contact surface 1231 of the cam 123 arranged on the one end of the first rack 120 is in contact with the contact end 1251 of the rotary bar 125. When the first rack 120 moves horizontally by a first distance and pushes the contact end 1251 of the rotary bar 125, the contact end 1251 of the rotary bar 125 may rotate forward along the inclined first contact surface 1231.

Here, the first distance refers to a left-right distance of the second door 16 between the starting point and the ending point of contact between the first contact surface 1231 and the rotary bar 125. The first contact surface 1231 is inclined forward with respect to the left-right direction of the second door 16 at the starting point of contact.

Continuously, the upper end of the latch bar 222 of the locking device 22 coupled with the rotary bar 125 rotates forward together with the rotary bar 125 around the hinge pin 225. The latch 224 coupled to the lower end of the latch bar 222 of the locking device 22 rotates rearward around the hinge pin 225. The latch hook 2241 formed on the front end of the latch 224 moves to the unlock position to be unlocked from the engaging wall 241 of the first door 15.

In the process of the first rack 120 moving from the first position by a first distance in a first direction, the first door 15 and the second door 16 may be unlocked (S2). Here, the first direction is the right direction from the second hinge 25 toward the locking device 22 (based on FIG. 23).

At the first position of the first rack 120, the second contact protrusion 1242 of the first rack 120 may be spaced apart from the operating protrusion 129 of the second rack 127. In the process of the first rack 120 moving in the first direction toward the locking device 22 to open the second door 16, the second contact protrusion 1242 may come close to the operating protrusion 129.

Before the second contact protrusion 1242 comes into contact with the operating protrusion 129, the moving force of the first rack 120 is not transmitted to the operating protrusion 129. Therefore, the second rack 127 remains stationary.

When the first rack 120 has moved from the first position by the first distance, the contact end 1251 of the rotary bar 125 may be located at a boundary between the first contact surface 1231 and the second contact surface 1232 or may be in contact with the second contact surface 1232.

When the first rack 120 has moved from the first position by the first distance, the second contact protrusion 1242 may come into contact with the operating protrusion 129. Through this, the driving force of the first rack 120 can be transmitted to the second rack 127.

When the first rack 120 moves from the first position by a second distance, the opening of the second door 16 may begin (S3). The second distance is larger than the first distance. In the process of the first rack 120 moving from the first position by the second distance, the contact between the rotary bar 125 and the second contact surface 1232 may be maintained while the rotary bar 125 is accommodated in the second contact surface 1232, such that the rotation angle of the rotary bar 125 can be maintained.

When the first rack 120 moves from the first position by the second distance, the second rack 127 moves together with the first rack 120 while the second contact protrusion 1242 of the first rack 120 and the operating protrusion 129 of the second rack 127 are in contact.

The first link 131 hinge-coupled to the body 128 of the second rack 127 through the first coupling pin 133 may move linearly together with the second rack 127. As the first coupling pin 133 of the first link 131 moves toward the third coupling pin 137, the first link 131 rotates clockwise around the first coupling pin 133 toward the front surface of the first door 15.

The second link 132, which is hinge-coupled to the first link 131 through the second coupling pin 134, rotates counterclockwise around the third coupling pin 137 toward the front surface of the first door 15. The first link 131 and the second link 132 may be arranged at a preset angle with respect to the body 128 of the second rack 127. The first link 131 and the second link 132 may protrude from the body 128 of the second rack 127 toward the first door 15.

The rotary wheel 139 of the second link 132 may apply pushing force the first door 15 while in contact with the front surface of the first door 15. The second door 16 may be rotated and open by a reactive force of the first door 15 with respect to an applying pushing force applied to the first door 15 through the rotary wheel 139.

The first rack 120 may move from the first position by a third distance and then stop while the second door 16 is open. Here, the third distance is larger than the second distance. The first rack 120 may stop at a second position.

The pusher 130 is positioned at the initial position until the first rack 120 moves from the first position by the second distance. When the first rack 120 moves from the first position by the third distance, the opening of the second door 16 is completed (S4).

After the opening of the second door 16 is completed, the motor may rotate in a second direction so that the first rack 120 can return to the first position which is the initial position (S5).

### 3. Description of door opening device 200 according to another embodiment

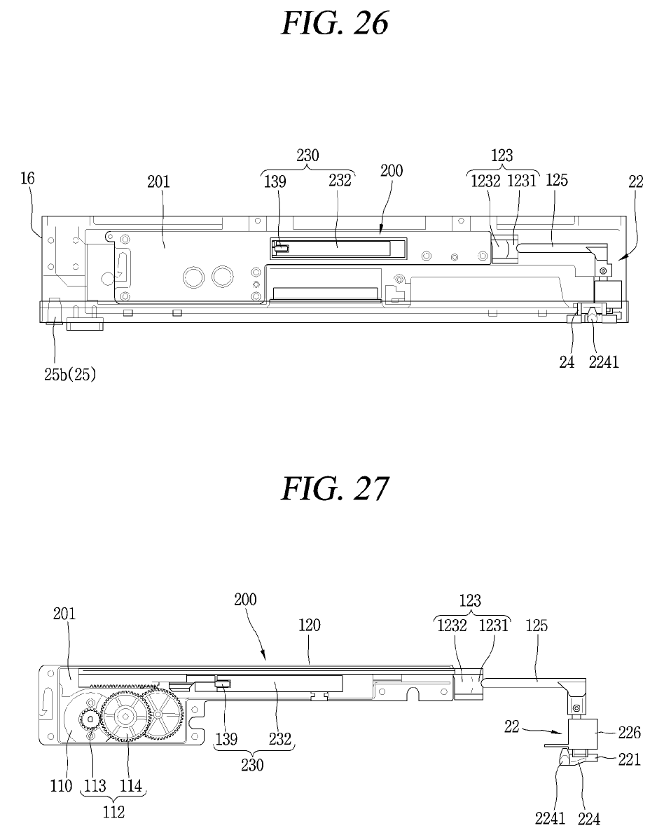

FIG. 26 is a conceptual view of a state in which a door opening device 200 according to another embodiment is installed inside the second door 16.

FIG. 27 is a conceptual view of a state in which the door opening device 200 is installed inside a case 201 in FIG. 26.

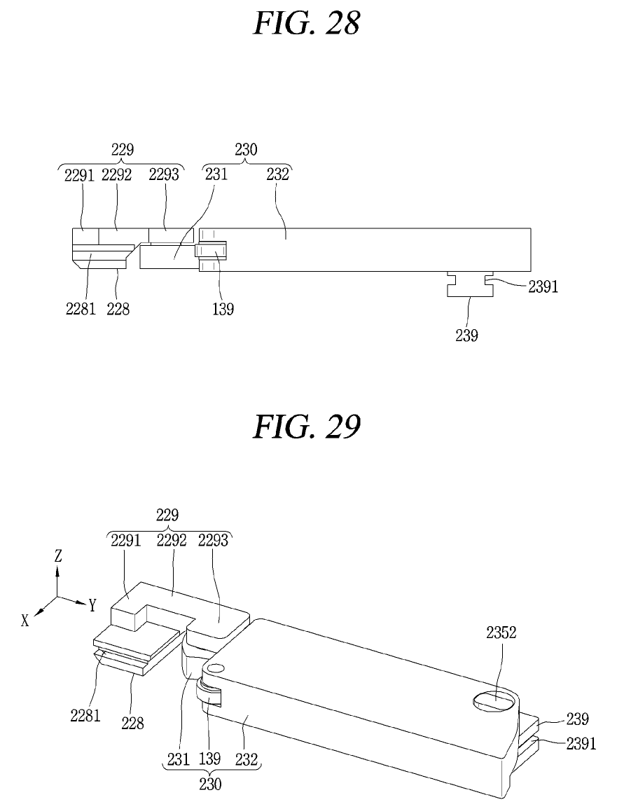

FIG. 28 is a conceptual view of a coupled state between a second rack 227 and a pusher 230 in FIG. 27, viewed from the rear of the second door 16.

FIG. 29 is a conceptual view of a coupled state between the second rack 227 and the pusher 230 in FIG. 28, viewed from above.

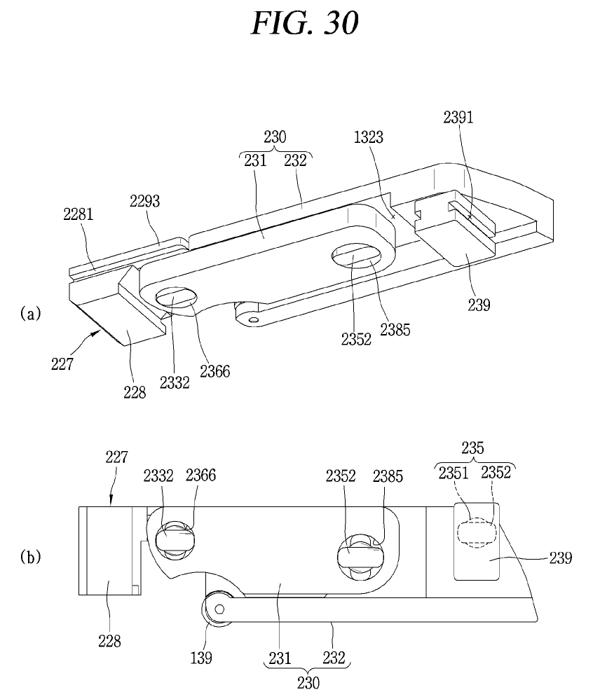

FIG. 30 is a set of a bottom perspective view and a bottom view of a coupled state between the second rack 227 and the pusher 230 in FIG. 29.

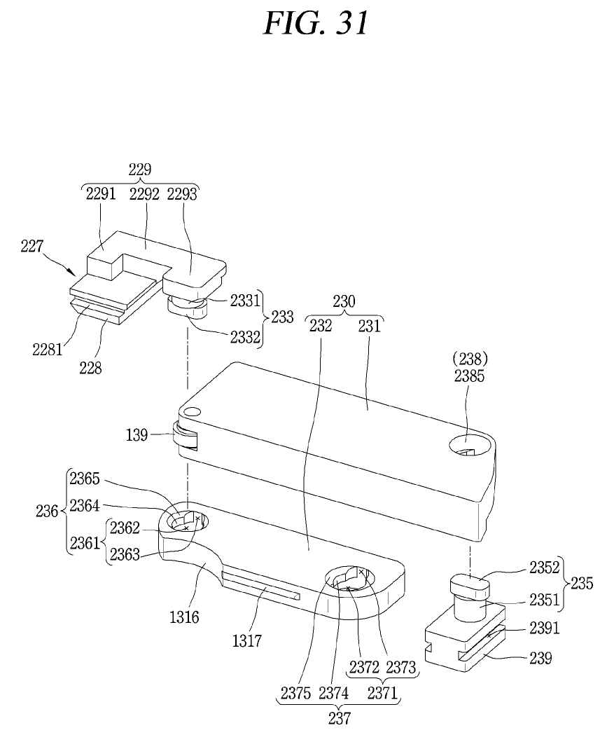

FIG. 31 is an exploded perspective view of the second rack 227 and the pusher 230 in FIG. 29.

This embodiment differs from the embodiment of FIGS. 1 to 25 in that the structure of the second rack 227 is simplified and the pusher 230 is rotatably coupled by keys 233, 234, and 235.

Other components are the same as or similar to those in the embodiment of FIGS. 1 to 25, so a redundant description will be omitted.

The second rack 227 includes a body 228. The body 228 of the second rack 227 may be simplified in structure and reduced in size compared to the body 128 of the second rack 127 according to the embodiment of FIG. 16 described above.

The body 228 may be formed in a rectangular shape. A thickness of the body 228 may be defined between upper and lower surfaces of the body 228. A second guide groove 2281 may be formed on each of front and rear surfaces of the body 228.

The body 228 may extend in the front-rear direction. A length of the body 228 in the front-rear direction may be larger than a width of the body 228 in the left-right direction.

The thickness of the body 228 may correspond to a thickness of a second link 232. The body 228 may be arranged not to overlap the second link 232 in the up-down direction but to be spaced apart from the second link 232 in the left-right direction.

Through this, the body 228 does not need to form a structure for rotatably supporting the first link 231 and the second link 232, so that the thickness of the body 228 of the second rack 227 can be significantly reduced.

By virtue of the simplified structure of the second rack 227, a lower space of the second link 232 can be used as a space for installing other components, for example, a lighting device, such as an LED.

An operating protrusion 229 may protrude upward from the upper surface of the body 228 toward the first rack 120. The operating protrusion 229 may include a first part 2291, a second part 2292, and a third part 2293. The first part 2291 may extend in the front-rear direction of the body 228. The second part 2292 may extend in the left-right direction of the body 228. The first part 2291 and the second part 2292 may protrude upward from the upper surface of the body 228.

The third part 2293 protrudes from the upper surface of the body 228 in the left-right direction. The third part 2293 is spaced apart from the first part 2291 in the left-right direction. A gap between the first part 2291 and the third part 2293 is larger than a width of the first contact protrusion 1241 in the left-right direction.

The first contact protrusion 1241 may be arranged between the first part 2291 and the third part 2293. When the first rack 120 is located at a first position, the first contact protrusion 1241 and the first part 2291 of the operating protrusion 229 may come into contact with each other. When the first rack 120 is located at the first position, the second contact protrusion 1242 may be spaced apart from the first part 2291 of the operating protrusion 229.

In the process of the first rack 120 moving toward a second position by a second distance, the second contact protrusion 1242 and the first part 2291 of the operating protrusion 229 may come into contact with each other. In the process of the second rack 227 moving by the second distance, the first contact protrusion 1241 may be spaced apart from the first part 2291 of the operating protrusion 229, and may be adjacent to or in contact with the third part 2293 of the operating protrusion 229.

The second part 2292 is configured to connect front portions of the first part 2291 and the third part 2293.

The pusher 230 may be rotatably supported by keys 233, 234, and 235.

The keys 233, 234, and 235 may include a first key 233, a second key 234, and a third key 235.

The keys 233, 234, and 235 may be inserted into key holes 2361, 2371, and 2381 and then rotated at a preset angle to lock or unlock two objects.

Each of the keys 233, 234, and 235 may include a shaft portion 2331, 2341, 2351 and a support portion 2332, 2342, 2352. The shaft portions 2331, 2341, and 2351 may be formed in a cylindrical shape. The shaft portions 2331, 2341, and 2351 may extend in the up-down direction. The shaft portions 2331, 2341, and 2351 may serve as rotary shafts of rotating bodies, for example, the first link 231 and the second link 232.

The corresponding support portion 2332, 2342, 2352 may be located on an upper or lower end of the corresponding shaft portion 2331, 2341, 2351. This embodiment shows an example in which the support portion 2332, 2342, 2352 is located on the lower end of the shaft portion 2331, 2341, 2351.

The support portions 2332, 2342, and 2352 may extend in one direction. A length of the corresponding support portion 2332, 2342, 2352 may be formed long in one direction. The length of the support portion 2332, 2342, 2352 may be larger than a diameter of the corresponding shaft portion 2331, 2341, 2351.

A width of the support portion 2332, 2342, 2352 may extend in a direction crossing the one direction. The width of the support portion 2332, 2342, 2352 may be smaller than the diameter of the corresponding shaft portion 2331, 2341, 2351. The length and width directions of the support portion 2332, 2342, 2352 may be perpendicular to each other.

A key accommodating portion 236, 237, 238 includes a key hole 2361, 2371, 2381 through which the corresponding key 233, 234, 235 is inserted. Each key hole 2361, 2371, and 2381 may include a shaft hole 2362, 2372, 2382 and a support hole 2363, 2373, 2383. The shaft hole 2362, 2372, 2382 accommodates the corresponding shaft portion 2331, 2341, 2351 of the key 233, 234, 235. The shaft hole 2362, 2372, 2382 is formed to correspond to the shape of the shaft portion 2331, 2341, 2351 of the key 233, 234, 235. The shaft hole 2362, 2372, 2382 may be formed through the key hole 2361, 2371, 2381 in the up-down direction.

Through this, the shaft hole 2362, 2372, 2382 has a diameter which is equal to a first diameter of the corresponding shaft portion 2331, 2341, 2351. The shaft hole 2362, 2372, 2382 may allow for the penetration of the shaft portion 2331, 2341, 2351, but may restrict the penetration of the support portion 2332, 2342, 2352.

The support hole 2363, 2373, 2383 is formed to correspond to the shape of the support portion 2332, 2342, 2352 of the key 233, 234, 235. The support hole 2363, 2373, 2383 may be formed through the key hole 2361, 2371, 2381 in the up-down direction. Through this, the support hole 2363, 2373, 2383 may allow for the penetration of the support portion 2332, 2342, 2352, but may restrict the penetration of the shaft portion 2331, 2341, 2351.

Each of the key accommodating portions 236, 237, and 238 may include an engaging portion 2364, 2374, 2384 and a support portion accommodating portion 2366, 2376, 2385. The engaging portion 2364, 2374, 2384 may be arranged on one side of the corresponding key accommodating portion 236, 237, 238. The engaging portion 2364, 2374, 2384 may protrude radially inward from an inner circumferential surface of the corresponding key accommodating portion 236, 237, 238.

The engaging portion 2364, 2374, 2384 may be formed through the corresponding key accommodating portion 236, 237, and 238 in the up-down direction. The shaft hole 2362, 2372, 2382 may be formed inside the engaging portion 2364, 2374, 2384 so that the shaft portion 2331, 2341, 2351 can be inserted therethrough. An inner surface of the engaging portion 2364, 2374, 2384 may be formed in a curved shape to surround the shaft portion 2331, 2341, 2351. An inner diameter of the engaging portion 2364, 2374, 2384 may be formed to correspond to the diameter of the shaft hole 2362, 2372, 2382.

The engaging portion 2364, 2374, 2384 may be arranged on the upper side of the key accommodating portion 236, 237, 238 based on an insertion direction of the key 233, 234, 235.

The engaging portion 2384 may be arranged as a plurality of engaging portions. The plurality of engaging portions 2364, 2374, and 2384 may be arranged to face each other radially. Each engaging portion 2364, 2374, and 2384 may extend in the circumferential direction.

The plurality of engaging portions 2364, 2374, and 2384 may be spaced apart in the circumferential direction. A support hole 2363, 2373, 2383 may be formed between adjacent engaging portions of the plurality of engaging portions 2364, 2374, 2384 in the circumferential direction. The support hole 2363, 2373, 2383 may be arranged as a plurality of support holes. The plurality of support holes 2363, 2373, and 2383 may be arranged radially facing each other on both sides of the shaft holes 2362, 2372, and 2382 with the shaft holes 2362, 2372, and 2382 as the center. The engaging portions 2364, 2374, and 2384 and the support holes 2363, 2373, and 2383 may be arranged alternately along the circumferential direction.

The support portion accommodating portions 2366, 2376, and 2385 may be formed in a cylindrical shape. A diameter of the support portion accommodating portion 2366, 2376, 2385 may be greater than or equal to a length of the corresponding support portion 2332, 2342, 2352. This embodiment shows an example in which the diameter of the support portion accommodating portion 2366, 2376, 2385 is equal to the length of the support portion 2332, 2342, 2352.

The support portion accommodating portion 2366, 2376, 2385 may be arranged on the other side of the key hole 2361, 2371, 2381 based on the insertion direction of the key 233, 234, 235 to accommodate the support portion 2332, 2342, 2352. The support portion accommodating portion 2366, 2376, 2385 may be formed to penetrate in the up-down direction to communicate with the key hole 2361, 2371, 2381 in the up-down direction.

The support portion accommodating portions 2366, 2376, and 2385 may allow the support portions 2332, 2342, and 2352 to rotate in place around the shaft portions 2331, 2341, and 2351 while accommodating the support portions 2332, 2342, and 2352.

Through this, the engaging portions 2364, 2374, and 2384 can allow the shaft portions 2331, 2341, and 2351 to be axially inserted through the shaft holes 2362, 2372, and 2382 as well as to rotate in place, but the support portions 2332, 2342, and 2352 can be caught by the engaging portions 2364, 2374, and 2384 and thus restrict the shaft portions 2331, 2341, and 2351 from moving along the axial direction in the support portion accommodating portions 2366, 2376, and 2385.

Inclined surfaces 2365 and 2375 may be formed on upper sides of the engaging portions 2364 and 2374 based on the insertion direction of the first key 233. The inclined surfaces 2365 and 2375 may be formed to be inclined with respect to the axial direction of the shaft portions 2331 and 2341. The inclined surfaces 2365 and 2375 may extend circumferentially along the perimeter of the engaging portions 2364 and 2374.

Through this, even though there is an error in aligning the first key 233 and the centers of the shaft holes 2362, 2372, and 2382 when inserting the first key 233, the inclined surfaces 2365 and 2375 can automatically adjust the alignment between the first key 233 and the centers of the shaft holes 2362, 2372, and 2382.

The lower surfaces of the engaging portions 2364, 2374, and 2384 may each be formed in a flat shape based on the insertion direction of the first key 233. Through this, the flat lower surfaces of the engaging portions 2364, 2374, and 2384 can engage in surface contact with the support portions 2332, 2342, and 2352, so that the engaging portions 2364, 2374, and 2384 can be rotatably supported by the engaged support portions 2332, 2342, and 2352.

The description of the shaft portions 2331, 2341, and 2351 and the support portions 2332, 2342, and 2352 of the keys 233, 234, and 235 may be applied to the first key 233 to the third key 235 unless otherwise specified.

The first key 233 may be arranged on the lower surface of the third part 2293 of the operating protrusion 229.

The first key 233 may include a first shaft portion 2331 and a first support portion 2332. The first shaft portion 2331 may protrude downward from the lower surface of the third part 2293. The first shaft portion 2331 is formed in a cylindrical shape having a first diameter. The first shaft portion 2331 may extend in a Z-axis direction in the orthogonal coordinate system.

The first support portion 2332 may extend in a Y-axis direction from the lower end of the first shaft portion 2331. The first support portion 2332 may extend in a direction crossing the longitudinal direction of the body 228 of the second rack 227. The body 228 of the second rack 227 may extend in an X-axis direction.

The first link 231 may extend long in the Y-axis direction. A width of the first link 231 may extend along the X-axis direction to be smaller than the length of the first link 231.

The first link 231 includes a first key accommodating portion 236. The first key accommodating portion 236 is formed through one end of the first link 231 in the Z-axis direction. A plurality of first engaging portions 2364 and first key holes 2361 may be arranged on one side of the first key accommodating portion 236 in the Z-axis direction.

Here, the one side of the first key accommodating portion 236 in the Z-axis direction means an upper side of the first key accommodating portion 236 based on the insertion direction of the first key 233.

The first key hole 2361 includes a first shaft hole 2362 and a plurality of first support holes 2363. The first shaft hole 2362 is formed through the center of the first key accommodating portion 236 in the Z-axis direction. The plurality of first support holes 2363 and the plurality of first engaging portions 2364 are alternately arranged in the circumferential direction along an inner circumferential surface of the first key accommodating portion 236.

A length of the first support hole 2363 may extend long in a width direction of the first link 231. A width of the first support hole 2363 may extend in the longitudinal direction of the first link 231 to be smaller than the length of the first support hole 2363.

A first inclined surface 2365 is formed on an upper side of each first engaging portion 2364 based on the insertion direction of the first key 233. The first inclined surface 2365 may guide the alignment of the center of the first shaft portion 2331 and the center of the first shaft hole 2362.

A first support portion accommodating portion 2366 is formed through another axial side of the first key accommodating portion 236 in the up-down direction. The first support portion accommodating portion 2366 is connected to the first shaft hole 2362 and the first support hole 2363 in communication.

The first key 233 may be connected to the first key accommodating portion 236 through the first shaft hole 2362 and the plurality of first support holes 2363.

Accordingly, the first link 231 can rotate around the first shaft portion 2331 of the first key 233. The first link 231 may be rotatably supported on the first support portion 2332 of the first key 233.

When the first support portion 2332 is arranged to overlap the first engaging portion 2364 in the Z-axis direction while being accommodated in the first support portion accommodating portion 2366, the first key 233 and the first key accommodating portion 236 may be locked to each other.

When the first support portion 2332 is arranged to overlap the first support hole 2363 in the Z-axis direction while being accommodated in the first support portion accommodating portion 2366, the first key 233 and the first key accommodating portion 236 may be unlocked to each other.

The first link 231 and the second link 232 may be coupled to be rotatable relative to each other by the second key 234. The second key 234 may be arranged in the link accommodating portion 1323 of the second link 232. The second key 234 may be accommodated inside the link accommodating portion 1323.

The second key 234 may include a second shaft portion 2341 and a second support portion 2342.

The second shaft portion 2341 of the second key 234 may protrude in the Z-axis direction from a lower surface of the second link 232. The second shaft portion 2341 may be located at the center of a center line passing through the center of the second link 232 in the Y-axis direction.

The second shaft portion 2341 may be arranged to be offset in the Y-axis direction from the center of the link accommodating portion 1323 of the second link 232.

The second support portion 2342 may extend in the Y-axis direction from the lower end of the second shaft portion 2341. A length of the second support portion 2342 is greater than a diameter of the second shaft portion 2341 and may extend in the longitudinal direction of the second link 232.

The second link 231 includes a second key accommodating portion 237. The second key accommodating portion 237 is formed through another end of the first link in the Z-axis direction. A plurality of second engaging portions 2374 and second key holes 2371 may be arranged on one side of the second key accommodating portion 237 in the Z-axis direction.

Here, the one side of the second key accommodating portion 237 in the Z-axis direction means an upper side of the second key accommodating portion 237 based on the insertion direction of the second key 234.

The second key hole 2371 includes a second shaft hole 2372 and a plurality of second support holes 2373. The second shaft hole 2372 is formed through the center of the second key accommodating portion 237 in the Z-axis direction. The plurality of second support holes 2373 and a plurality of second engaging portions 2374 are alternately arranged in the circumferential direction along an inner circumferential surface of the second key accommodating portion 237.

A length of the second support hole 2373 may extend long in a width direction of the first link 231. A width of the second support hole 2373 may extend in the longitudinal direction of the first link 231 to be smaller than the length of the second support hole 2373.

A second inclined surface 2375 is formed on an upper side of each second engaging portion 2374 based on the insertion direction of the second key 234. The second inclined surface 2375 may guide the alignment of the center of the second shaft portion 2341 and the center of the second shaft hole 2372.

A second support portion accommodating portion 2376 is formed through another axial side of the second key accommodating portion 237 in the up-down direction. The second support portion accommodating portion 2376 is connected to the second shaft hole 2372 and the second support hole 2373 in communication.

The second key 234 may be connected to the second key accommodating portion 237 through the second shaft hole 2372 and the plurality of second support holes 2373.

Through this, the first link 231 can be hinge-coupled to the second link 232 through the second shaft portion 2341 of the second key 234, to be rotatable relative to the second link 232. One end of the second link 232 may be rotatably supported by the second support portion 2342 by the second key 234.

When the second support portion 2342 is arranged to overlap the second engaging portion 2374 in the Z-axis direction while being accommodated in the second support portion accommodating portion 2376, the second key 234 and the second key accommodating portion 237 may be locked to each other.

When the second support portion 2342 is arranged to overlap the second support hole 2373 in the Z-axis direction while being accommodated in the second support portion accommodating portion 2376, the second key 234 and the second key accommodating portion 237 may be unlocked from each other.

The second link 232 may be rotatably installed inside the case 201 by a third key 235.

The third key 235 may be arranged on a link support portion 239. The link support portion 239 may be accommodated inside the case 201. The link support portion 239 may be formed in a rectangular shape. A length of the link support portion 239 may extend in the X-axis direction. A width of the link support portion 239 may extend in the Y-axis direction.

A coupling groove 2391 may be formed concavely in the Y-axis direction on each of left and right surfaces of the link support portion 239. The coupling grooves 2391 may extend in the X-axis direction. A coupling protrusion may protrude inside the case 201 toward the coupling groove 2391. The coupling protrusion may be inserted into the coupling groove 239.

With the configuration, the coupling protrusion 239 can restrict the link support portion 239 from moving in the case 201 in the Z-axis direction. The coupling protrusion can allow the link support portion 239 to move in the X-axis direction.

The third key 235 may be arranged on an upper surface of the link support portion 239. The third key 235 may be arranged on a lower portion of the second link 232.

The third key 235 may include a third shaft portion 2351 and the third support portion 2352.

The third shaft portion 2351 of the third key 235 may protrude in the Z-axis direction from an upper surface of the link support portion 239. The third shaft portion 2351 may be arranged to be offset in the X-axis direction from the center of the link support portion 239.

The third support portion 2352 may extend in the Y-axis direction from the upper end of the third shaft portion 2351. A length of the third support portion 2352 is greater than a diameter of the third shaft portion 2351 and may extend in the longitudinal direction of the third key 235.

The second link 232 includes a third key accommodating portion 238. The third key accommodating portion 238 is formed through one corner of the second link 232 in the Z-axis direction. For example, the third key accommodating portion 238 may be arranged adjacent to a corner where the front and left surfaces of the second link 232 are connected.

A plurality of third engaging portions 2384 and third key holes 2381 may be arranged on one side of the third key accommodating portion 238 in the Z-axis direction.

Here, the one side of the third key accommodating portion 238 in the Z-axis direction means a lower side of the third key accommodating portion 238 based on the insertion direction of the third key 235.

The third key hole 2381 includes a third shaft hole 2382 and a plurality of third support holes 2383. The third shaft hole 2382 is formed through the center of the third key accommodating portion 238 in the Z-axis direction. The plurality of third support holes 2383 and the plurality of third engaging portions 2384 are alternately arranged in the circumferential direction along an inner circumferential surface of the third key accommodating portion 238.

A length of the third support hole 2383 may extend long in a width direction of the second link 232. A width of the third support hole 2383 may extend in the longitudinal direction of the second link 232 to be smaller than the length of the third support hole 2383.

A third support portion accommodating portion 2385 is formed through another axial side of the third key accommodating portion 238 in the up-down direction. The third support portion accommodating portion 2385 is connected to the third shaft hole 2382 and the third support hole 2383 in communication.

The third key 235 may be coupled to the third key accommodating portion 238 through the third shaft hole 2382 and the plurality of third support holes 2383.

Through this, the second link 232 can be hinge-coupled to the link support portion 239 through the third shaft portion 2351 of the third key 235, to be rotatable relative to the link support portion 239. Another end of the second link 232 may be rotatably supported by the third support portion 2352 by the third key 235.

When the third support portion 2352 is arranged to overlap the third engaging portion 2384 in the Z-axis direction while being accommodated in the third support portion accommodating portion 2385, the third key 235 and the third key accommodating portion 238 may be locked to each other.

When the third support portion 2352 is arranged to overlap the third support hole 2383 in the Z-axis direction while being accommodated in the third support portion accommodating portion 2385, the third key 235 and the third key accommodating portion 238 may be unlocked from each other.

When the first link 231 and the second link 232 are arranged to overlap in the Z-axis direction, the front surface of the second rack 227, the front surface of each of the first link 231 and the second link 232, and the front surface of the link support portion 239 may form the same plane in the Y-axis direction.

Here, when the first link 231 and the second link 232 are arranged to overlap in the Z-axis direction, a longitudinal center line of the first link 231 passing through the center of the first link 231 in the Y-axis direction and a longitudinal center line of the second link 232 passing through the center of the second link 232 in the Y-axis direction may be arranged parallel to each other.

A distance between the front surface of the first link 231 and the center of the first shaft portion 2331 in the X-axis direction is smaller than a distance between the front surface of the first link 231 and the center of the second shaft portion 2341 in the X-axis direction.

Through this, a driving force in the Y-axis direction, which is transmitted from the second rack 227 to the first link 231 through the first key 233, can be converted into a clockwise moment or torque at the second key 234 (based on FIG. 30). Accordingly, the first link 231 can rotate toward the first door 15 relative to the body 228 of the second rack 227 around the first shaft portion 2331 of the first key 233.

A distance between the front surface of the second link 232 and the center of the second shaft portion 2341 in the X-axis direction is larger than a distance between the front surface of the second link 232 and the center of the third shaft portion 2351 in the X-axis direction.

Through this, a driving force in the X-axis direction, which is transmitted from the first link 231 to the second link 232 through the second key 234, can be converted into a counterclockwise moment or torque at the third key 235 (based on FIG. 30). Accordingly, the second link 232 can rotate toward the first door 15 relative to the link support portion 239 around the third shaft portion 2351 of the third key 235.

The pusher 230 may apply an applying pushing force to the front surface of the first door 15 by the relative rotation of the first link 231 and the second link 232. The second door 16 can be open by the reactive force against the applying pushing force of the pusher 230.

Therefore, according to this embodiment, the first link 231 and the second link 232 can be rotatably installed inside the second door 16 by the first key 233 to the third key 235. The first key 233 includes a first shaft portion 2331 extending in the Z-axis direction from the third part 2293 formed on the upper portion of the second rack 227, and a first support portion 2332 extending in the Y-axis direction from the first shaft portion 2331.

One end of the first link 231 is hinge-coupled to the first key 233 through the first key accommodating portion 236, so that another end of the first link 231 can rotate around the first shaft portion 2331. The one end of the first link 231 may be rotatably supported by the first support portion 2332 of the first key 33 while being caught on the upper portion of the second rack 227.

The second link 232 includes a link accommodating portion 1323 for accommodating a portion of the first link 231. The second key 234 includes a second shaft portion 2341 extending in the Z-axis direction from an upper side of the link accommodating portion 1323 of the second link 232, and a second support portion 2342 extending in the Y-axis direction from the second shaft portion 2341.

Another end of the first link 231 may be hinge-coupled to the second key 234 through the second key accommodating portion 237, so that the another end of the first link 231 and one end of the second link 232 can rotate relative to each other around the second shaft portion 2341. The other end of the first link 231 may be rotatably supported by the second support portion 2342 of the second key 33 while being caught on an upper side of the inner surface of the second link 232.

The third key 235 includes a third shaft portion 2351 extending in the Z-axis direction from an upper surface of the link support portion 239, and a third support portion 2352 extending in the Y-axis direction from the third shaft portion 2351.

Another end of the second link 232 is hinge-coupled to the third key 235 through the third key accommodating portion 238, so that the one end of the second link 232 can rotate around the third shaft portion 2351. The other end of the second link 232 can be rotatably supported by the third support portion 2352 of the third key 235 while being caught on the upper portion of the link support portion 239.

Through this, the first shaft portion 2331 to the third shaft portion 2351 can be reduced to a length, which is equal to a thickness of the first link 231 or the second link 232. The first support portion 2332 to the third support portion 2352 may rotatably support the first link 231 and the second link 232 while being caught on the upper portion of the second rack 227 and the link support portion 239, respectively.

Accordingly, the first key 233 to the third key 235 can replace the coupling pin structure according to the embodiment of FIGS. 1 to 25, so as to simplify the coupling structure of the second rack 227 and the first link 231, the coupling structure of the first link 231 and the second link 232, and the coupling structure of the link support portion 239 and the second link 232, and modularize the second rack 227 and the pusher 230 into a single assembly for compact arrangement.

In the embodiments of FIGS. 26 to 31, the first key 233 and the first key accommodating portion 236 are formed on one end of the second rack 227 and one end of the first link 231, respectively, but may be formed on opposite positions. The second key 234 and the second key accommodating portion 237, and the third key 235 and the third key accommodating portion 238 may also be changed to opposite positions.

Hereinafter, a method of assembling the second rack 227, the pusher 230, and the link support portion 239 will be described.

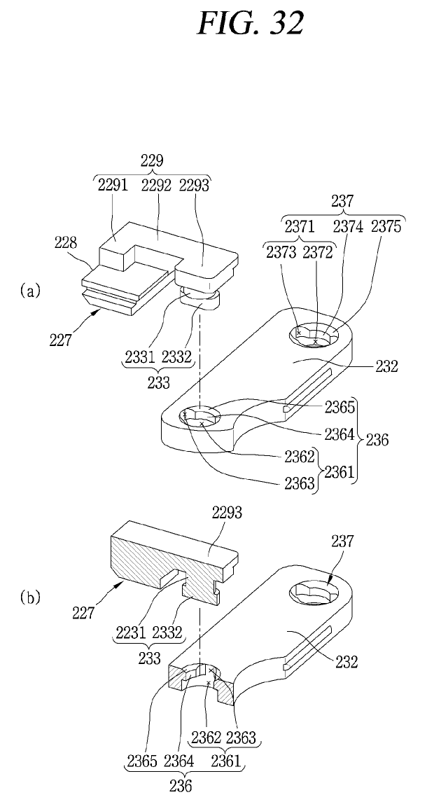

FIG. 32 is a set of an exploded view and a cross-sectional view of a state before the first key 233 of the second rack 227 is coupled to the first key accommodating portion 236 of the first link 231.

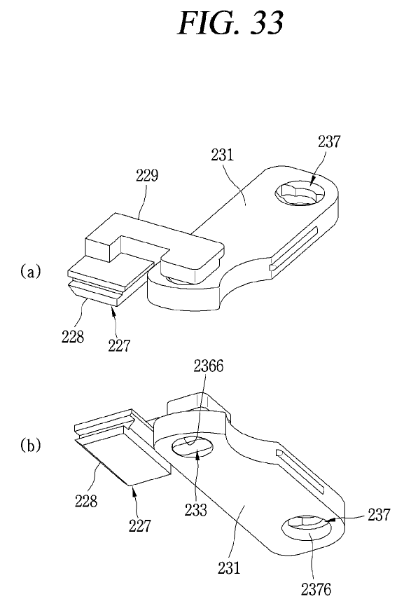

FIG. 33 is a conceptual view of a state in which the first key 233 is temporarily coupled by insertion into the first key hole 2361 of the first key accommodating portion 236 in FIG. 32.

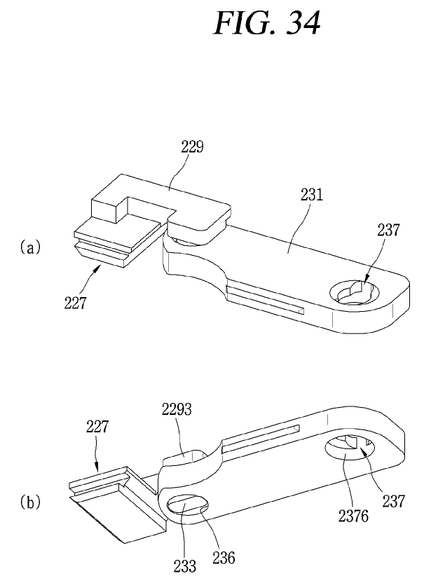

FIG. 34 is a conceptual view of a state in which the first link 231 is rotated 90 degrees around the first key 233 and coupled to the first key 233 in FIG. 33.

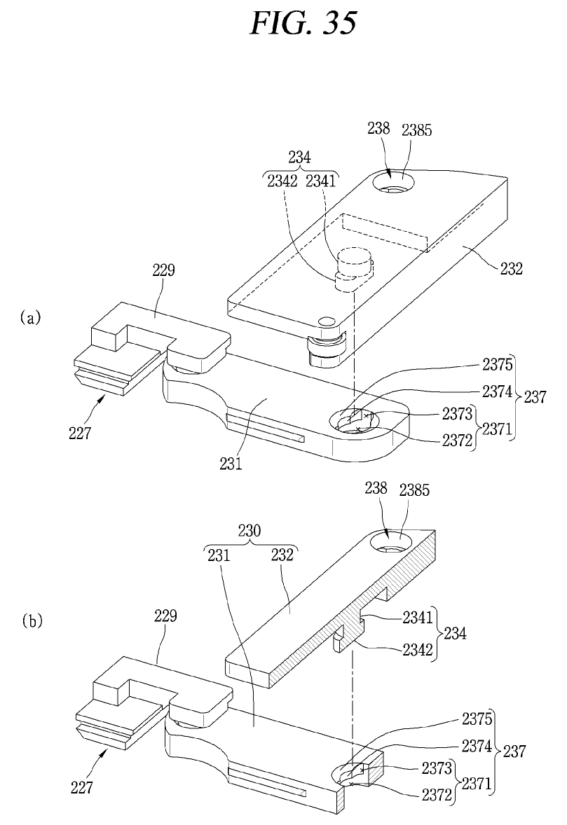

FIG. 35 is a set of an exploded view and a cross-sectional view of a state before the second key 234 of the second link 232 is coupled to the second key accommodating portion 237 of the first link 231 in FIG. 34.

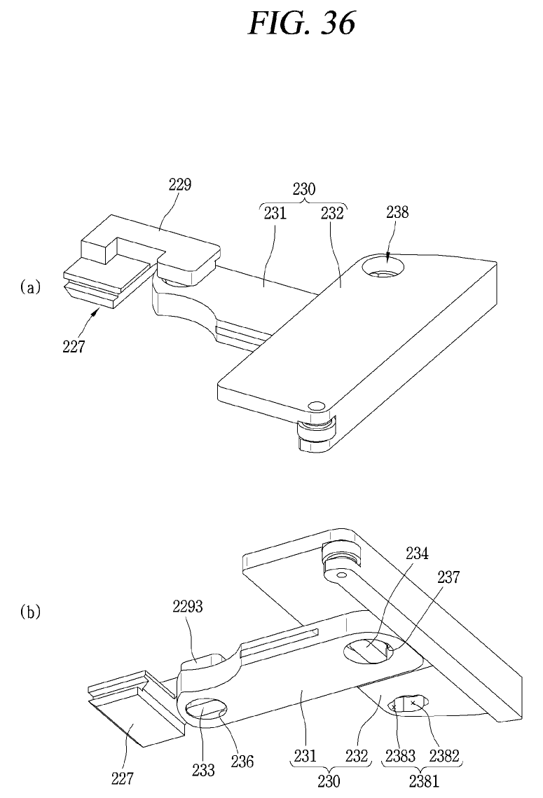

FIG. 36 is a conceptual view of a state in which the second key 234 is temporarily coupled by insertion into the second key hole 2371 of the second key accommodating portion 237 in FIG. 35.

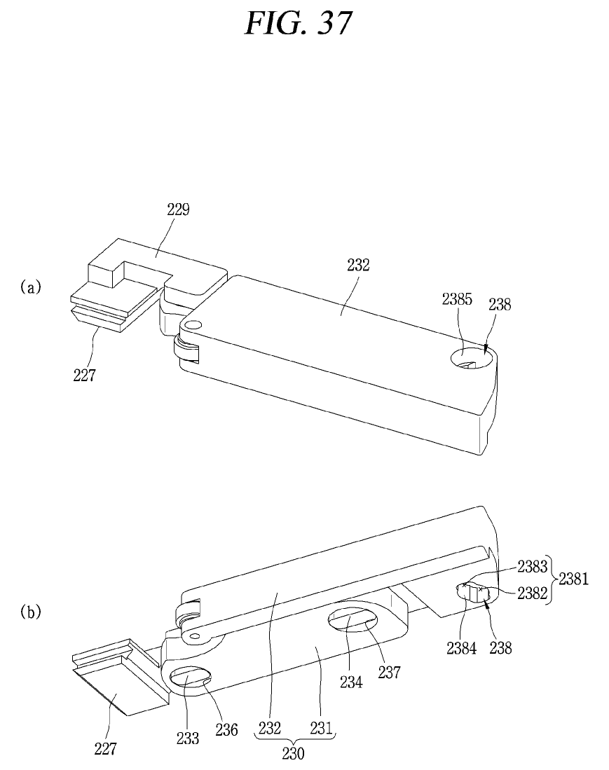

FIG. 37 is a conceptual view of a state in which the first link 231 and the second link 232 are coupled to each other by 90-degree rotation of the second link 232 around the second key 234.

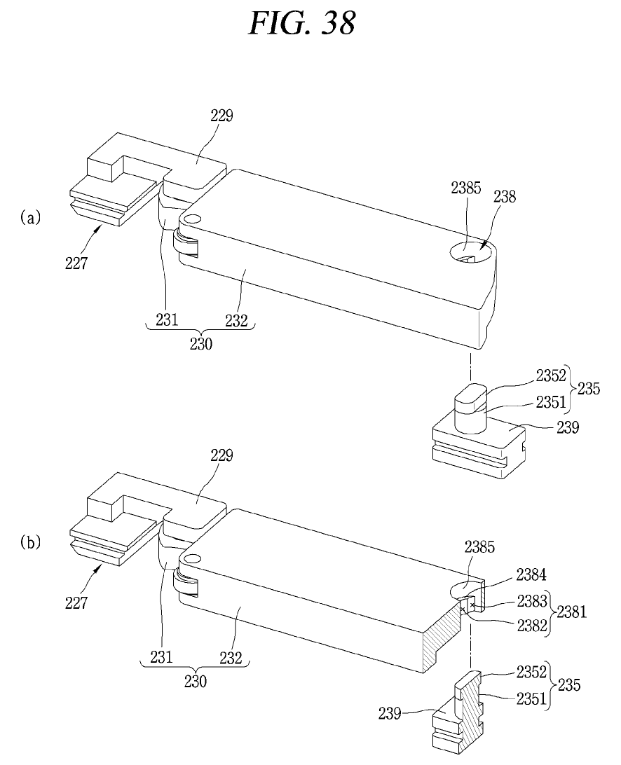

FIG. 38 is a set of an exploded view and a cross-sectional view of a state before the third key 235 of the link support portion 239 is coupled to the third key accommodating portion 238 of the second link 232 in FIG. 37.

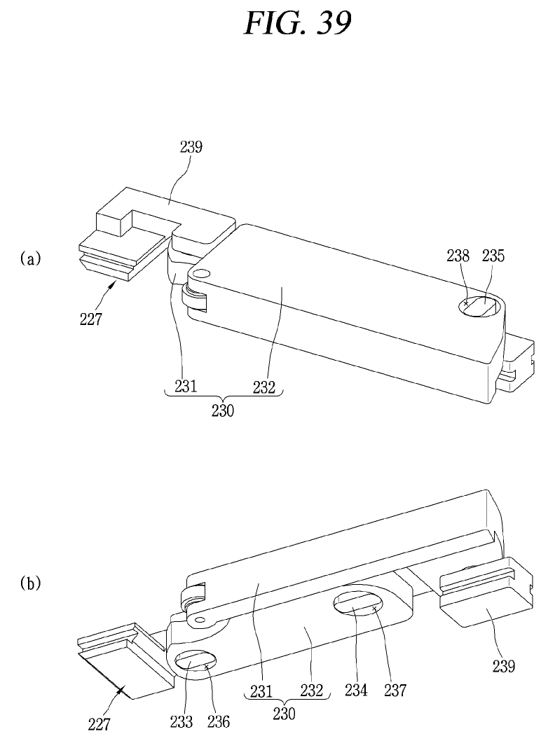

FIG. 39 is a conceptual view of a state in which the third key 235 is temporarily coupled by insertion into the third key hole 2381 of the third key accommodating portion 238 in FIG. 38.

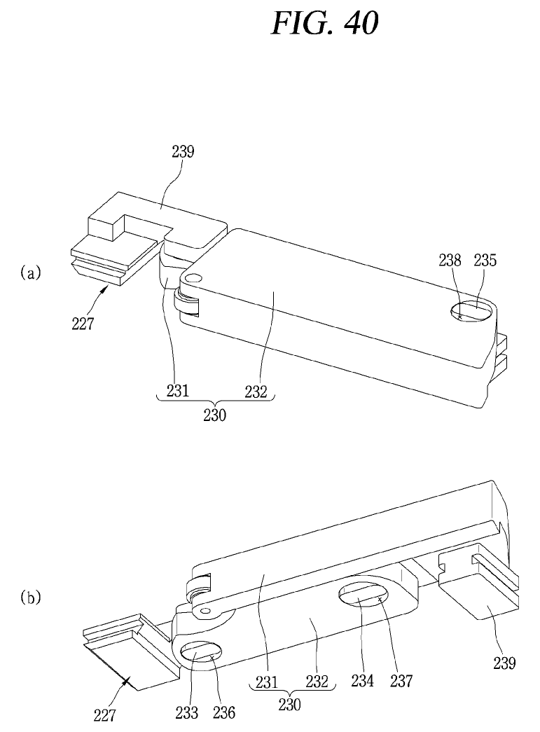

FIG. 40 is a conceptual view of a state in which the second link 232 and the link support portion 239 are coupled to each other by 90-degree rotation of the link support portion 239 around the third key 235.

According to this embodiment, the second rack 227, the pusher 230, and the link support portion 239 may be assembled in the following order.

First, the second rack 227 and the first link 231 may be assembled.

The first key 233 of the second rack 227 may be positioned above the first key accommodating portion 236 of the first link 231. The first support portion 2332 of the first key 233 and the first support hole 2363 of the first key accommodating portion 236 are aligned to overlap each other in the Z-axis direction.

The length of the body 228 of the second rack 227 extends in the X-axis direction. The length of the first support portion 2332 extends in the Y-axis direction crossing the longitudinal direction of the body 228 of the second rack 227. The third part 2293 of the second rack 227 and the first link 231 are positioned parallel to each other in the X-axis direction so that the longitudinal center line of the first support hole 2363 and the longitudinal center line of the first support portion 2332 are aligned in the Z-axis direction (see FIG. 32).

Next, the first key 233 is temporarily coupled by insertion into the first key accommodating portion 236, so that the first support portion 2332 passes through the first shaft hole 2362 and the first support hole 2363 and is accommodated in the first support portion accommodating portion 2366 (see FIG. 33). At this stage, the first support portion 2332 of the first key 233 and the first support hole 2363 of the first key accommodating portion 236 are arranged to overlap each other in the Z-axis direction. Accordingly, the second rack 227 and the first link 231 are in an unlocked state to be separated from each other in the Z-axis direction.

Next, the first link 231 rotates 90 degrees while the first support portion 2332 is accommodated in the first support portion accommodating portion 2366 (see FIG. 34). At this stage, the first support portion 2332 of the first key 233 and the first engaging portion 2364 of the first key accommodating portion 236 are arranged to overlap each other in the Z-axis direction. Accordingly, the first support portion 2332 and the first engaging portion 2364 can engage with each other in the Z-axis direction. Therefore, the first support portion 2332 is caught by the first engaging portion 2364, making it impossible to separate the second rack 227 and the first link 231 from each other in the Z-axis direction. However, the first link 231 is rotatable relative to the second rack 227 around the first key 233.

Second, the first link 231 and the second link 232 may be assembled.

The second key 234 of the second rack 232 may be positioned above the second key accommodating portion 237 of the first link 231. The second support portion 2342 of the second key 234 and the second support hole 2373 of the second key accommodating portion 237 are aligned to overlap each other in the Z-axis direction.

The first link 231 and the second link 232 are arranged to perpendicularly cross each other, so that the longitudinal center line of the second support portion 2342 is arranged in the X-axis direction crossing the longitudinal direction of the first link 231 and the longitudinal center line of the second support portion 2342 is aligned with the longitudinal center line of the second support hole 2373 in the Z-axis direction (see FIG. 35).

Next, the second key 234 is temporarily coupled by insertion into the second key accommodating portion 237 in the Z-axis direction, so that the second support portion 2342 passes through the second shaft hole 2372 and the second support hole 2373 and is accommodated in the second support portion accommodating portion 2376 (see FIG. 36). At this stage, the second support portion 2342 of the second key 234 and the second support hole 2373 of the second key accommodating portion 237 are arranged to overlap each other in the Z-axis direction. Accordingly, the first link 231 and the second link 232 are in an unlocked state to be separated from each other in the Z-axis direction.

Next, the second link 232 rotates 90 degrees while the second support portion 2342 is accommodated in the second support portion accommodating portion 2376 (see FIG. 37). At this stage, the second support portion 2342 of the second key 234 and the second engaging portion 2374 of the second key accommodating portion 237 are arranged to overlap each other in the Z-axis direction. Accordingly, the second support portion 2342 and the second engaging portion 2374 can engage with each other in the Z-axis direction. Therefore, the second support portion 2342 is caught by the second engaging portion 2374, making it impossible to separate the first link 231 and the second link 232 from each other in the Z-axis direction. However, the relative rotation of the first link 231 and the second link 232 is possible.

Third, the second link 232 and the link support portion 239 may be assembled.

The third key 235 of the link support portion 239 may be positioned below the third key accommodating portion 238 of the second link 232. The third support portion 2352 of the third key 235 and the third support hole 2383 of the third key accommodating portion 238 are aligned to overlap each other in the Z-axis direction.

The second link 232 and the link support portion 239 are arranged parallel to each other in the Z-axis direction, so that the longitudinal center line of the third support portion 2352 is arranged in the X-axis direction crossing the longitudinal direction of the second link 232 and the longitudinal center line of the third support portion 2352 is aligned with the longitudinal center line of the third support hole 2383 in the Z-axis direction (see FIG. 38).

Next, the third key 235 is temporarily coupled by insertion into the third key accommodating portion 238 in the Z-axis direction, so that the third support portion 2352 passes through the third shaft hole 2382 and the third support hole 2383 and is accommodated in the third support portion accommodating portion 2385 (see FIG. 39). At this stage, the third support portion 2352 of the third key 235 and the third support hole 2383 of the third key accommodating portion 238 are arranged to overlap each other in the Z-axis direction. Accordingly, the second link 232 and the link support portion 239 are in an unlocked state to be separated from each other in the Z-axis direction.

Next, the link support portion 239 rotates 90 degrees while the third support portion 2352 is accommodated in the third support portion accommodating portion 2385 (see FIG. 40). At this stage, the third support portion 2352 of the third key 235 and the third engaging portion 2384 of the third key accommodating portion 238 are arranged to overlap each other in the Z-axis direction. Accordingly, the third support portion 2352 and the third engaging portion 2384 can engage with each other in the Z-axis direction. Therefore, the third support portion 2352 is caught by the third engaging portion 2384, making it impossible to separate the second link 232 and the link support portion 239 from each other in the Z-axis direction. However, the relative rotation of the second link 232 with respect to the link support portion 239 is possible.

What is claimed is:

1. A refrigerator comprising:
a cabinet having a storage chamber;
a first door rotatably mounted on the cabinet to open and close the storage chamber, and having an opening;
a second door rotatably mounted on the first door to open and close the opening; and
a door opening device installed inside the second door and configured to automatically open the second door,
wherein the door opening device comprises:
a case;
a driving unit installed inside the case;
a pusher connected to the driving unit and applying pushing force the first door by receiving a driving force from the driving unit; and
a rotary wheel mounted on one side of the pusher to be contactable with the first door, and
the pusher applies pushing force the first door through the rotary wheel while in contact with the first door, and the second door is open by a reactive force of the first door against an applying pushing force of the pusher.

2. The refrigerator of claim 1, wherein the rotary wheel is formed in one or a combined shape of at least two of a cylindrical shape, a spherical shape, and a circular shape, and
a center of the rotary wheel is rotatably supported on one side of the pusher by a central shaft, and an outer circumferential surface of the rotary wheel is in rolling-contact with the first door according to the rotation of the pusher.

3. The refrigerator of claim 1, wherein the second door and the first door are arranged in a front-rear direction of the cabinet, and
the door opening device further comprises:
a first rack extending in a left-right direction and installed inside the case to be linearly movable in the left-right direction by receiving the driving force of the driving unit; and
a second rack connected to the first rack and mounted to be linearly movable in the left-right direction together with the first rack.

4. The refrigerator of claim 3, wherein the pusher comprises:
a first link hinge-coupled to the second rack by a first coupling pin, and linearly moving and rotating simultaneously according to the movement of the second rack; and
a second link hinge-coupled to one end of the first link via a second coupling pin and rotating in an opposite direction to a rotational direction of the first link around a third coupling pin, and
the rotary wheel is rotatably mounted on one end of the second link toward an opposite direction to the third coupling pin based on the second coupling pin.

5. The refrigerator of claim 4, wherein the second link comprises:
a link accommodating portion accommodating a portion of the first link, and
another end of the first link is accommodated in the link accommodating portion and hinge-coupled to the second link by the second coupling pin.

6. The refrigerator of claim 3, wherein the driving unit comprises a motor, and
further comprises a driving force transmission unit configured to transmit the driving force of the driving unit to the first rack,
the driving force transmission unit comprises:
a driving gear connected to the driving unit; and
a driven gear engaged with the driving gear at a preset gear ratio, and
the first rack comprises a rack gear engaged with the driven gear.

7. The refrigerator of claim 3, wherein the first rack comprises:
a first contact protrusion; and
a second contact protrusion arranged to be spaced apart from the first contact protrusion in the left-right direction, and
the second rack comprises:
a body extending in the left-right direction; and
an operating protrusion protruding toward the first rack from one side of the body and arranged between the first contact protrusion and the second contact protrusion to be selectively in contact with one of the first contact protrusion and the second contact protrusion according to a change in position of the first rack, such that the second rack moves in one direction when the operating protrusion and the first contact protrusion are brought into contact, and moves in an opposite direction to the one direction when the operating protrusion and the second contact protrusion are brought into contact.

8. The refrigerator of claim 7, wherein the first rack further comprises a connection protrusion extending in the left-right direction between the first contact protrusion and the second contact protrusion, to connect the first contact protrusion and the second contact protrusion, and
the operating protrusion comprises:
a first part extending in the front-rear direction and arranged between the first contact protrusion and the second contact protrusion to be selectively in contact with one of the first contact protrusion and the second contact protrusion; and
a second part extending in the left-right direction from one end of the first part.

9. The refrigerator of claim 3, further comprising a locking device arranged inside the second door to lock or unlock the first door and the second door,
wherein the locking device comprises:
a latch bar extending in an up-down direction and mounted to be rotatable around a hinge pin in the front-rear direction;
a latch protruding from a lower end of the latch bar toward the first door;
a latch hook protruding upward from the latch to be caught on an engaging portion arranged on the first door; and
an operating unit protruding from the lower end of the latch bar toward outside of the second door, so as to be operated by a user.

10. The refrigerator of claim 9, wherein the door opening device comprises a cam arranged on one end of the first rack, and configured to transmit a driving force of the first rack to the locking device to unlock the locking device when the second door is open,
the cam comprises:
a first contact surface formed inside the case to be inclined in a direction away from the locking device with respect to the front-rear direction; and
a second contact surface extending in the left-right direction from the first contact surface,
the locking device comprises a rotary bar having one end coupled to an upper end of the latch bar, and another end extending toward the first contact surface in the left-right direction to be in contact with the first contact surface, and
when the cam moves toward the rotary bar, the rotary bar rotates toward the first door along the first contact surface, so that the locking device is unlocked.

11. The refrigerator of claim 10, wherein the other end of the rotary bar has a spherical or hemispherical shape.

12. The refrigerator of claim 1, wherein the pusher comprises:
a first link rotatably installed inside the case; and
a second link hinge-coupled to one end of the first link to be rotatable in conjunction with the first link, and
the first link and the second link are coupled by a key to be rotatable in opposite directions.

13. The refrigerator of claim 12, wherein the key comprises:
a shaft portion serving as a rotational shaft of the first link or the second link; and
a support portion protruding radially outward from one end of the shaft portion, and rotatably supporting the first link or the second link,
a key accommodating portion is formed on the first link or the second link, and
the key accommodating portion comprises:
a shaft hole formed through the first link or the second link in the up-down direction to accommodate the shaft portion; and
a support hole recessed radially outward in the shaft hole such that the support portion passes therethrough.

14. The refrigerator of claim 13, wherein the support portion is arranged as a plurality of support portions, arranged to face each other in a radial direction of the shaft portion.

15. The refrigerator of claim 13, wherein the key accommodating portion comprises:
a support portion accommodating portion formed on one side of the shaft hole and the support hole based on an axial direction of the shaft portion, so that the support portion is rotatable while being accommodated therein.

16. The refrigerator of claim 1, wherein the pusher comprises:
a first link mounted to be rotatable around the first key; and
a second link hinge-coupled to the first link via a second key and mounted to be rotatable around a third key in an opposite direction to the first link, and
the rotary wheel is rotatably mounted on one end of the second link toward an opposite direction to the third key based on the second key.

17. The refrigerator of claim 16, wherein the door opening device comprises:
a first rack mounted to be linearly movable in both directions by receiving the driving force from the driving unit; and
a second rack connected to the first rack to be linearly movable in the both directions together with the first rack, and
one end of the first link is hinge-coupled to the second rack by the first key, and is rotatable while linearly moving together with the second rack.

18. The refrigerator of claim 17, wherein the first key comprises:
a first shaft portion extending from one side of the second rack and serving as a rotational shaft of the first link; and
a first support portion protruding radially outward from one end of the first shaft portion to rotatably support the first link,
a first key accommodating portion is arranged on one end of the first link, and
the first key accommodating portion comprises:
a first shaft hole formed therethrough in the up-down direction to accommodate the first shaft portion; and
a first support hole recessed radially outward into the shaft hole, such that the first support portion passes therethrough.

19. The refrigerator of claim 16, wherein the second key comprises:
a second shaft portion protruding from one side of the second link and coupled through the first link to be rotatable relative to the first link; and
a second support portion protruding radially outward from one end of the second shaft portion to rotatably support the first link,
a second key accommodating portion is arranged on another end of the first link, and
the second key accommodating portion comprises:
a second shaft hole formed therethrough in the up-down direction to accommodate the second shaft portion; and
a second support hole recessed radially outward into the second shaft hole, such that the second support portion passes therethrough.

20. The refrigerator of claim 16, wherein the door opening device further comprises a link support portion installed inside the case,
the third key comprises:
a third shaft portion protruding from the link support portion and serving as a rotational shaft of the second link; and
a third support portion protruding radially outward from one end of the third shaft portion to rotatably support the second link,
a third key accommodating portion is arranged on another end of the second link, and
the third key accommodating portion comprises:
a third shaft hole formed therethrough in the up-down direction to accommodate the third shaft portion; and
a third support hole recessed radially outward into the third shaft hole, such that the third support portion passes therethrough.
